(19) United States
(12) Patent Application Publication
(10) Pub. No.: US 2025/0306492 A1
(43) Pub. Date: Oct. 2, 2025

(54) TONER

(71) Applicant: CANON KABUSHIKI KAISHA, Tokyo (JP)

(72) Inventors: YUU NISHIMURA, Chiba (JP); MIZUKI SAITO, Chiba (JP); KOHEI YOSHIYAMA, Chiba (JP); NOBUHIRO YOSHIDA, Ibaraki (JP); HITOSHI SANO, Chiba (JP); TORU TAKAHASHI, Ibaraki (JP); KENTARO KAMAE, Kanagawa (JP); TAKAHO SHIBATA, Tokyo (JP)

(21) Appl. No.: 19/087,434

(22) Filed: Mar. 21, 2025

(30) Foreign Application Priority Data
Mar. 26, 2024 (JP) 2024-049225
Feb. 27, 2025 (JP) 2025-030139

(51) Int. Cl. G03G 9/087; G03G 9/097

(52) U.S. Cl. CPC G03G 9/08755; G03G 9/09708

(57) ABSTRACT

A toner includes toner particles containing a binder resin and a release agent. The binder resin contains an amorphous resin A and a crystalline polyester C. The amorphous resin A is a polyester and has, as a structure that forms a polyester backbone, (i) a polyethylene terephthalate structural moiety and (ii) a unit having a specified structure. An SP value of the amorphous resin A is represented by SP_{A}, an SP value of the crystalline polyester C is represented by SP_{C}, and a formula 1.00≤SP_{A}-SP_{C}≤1.35 is satisfied. The toner contains at least one metal element selected from the metal element group consisting of calcium, magnesium, sodium, and barium and contains aluminum.

### BACKGROUND

### Technical Field

The present disclosure relates to a toner used in an electrophotographic system, an electrostatic recording system, an electrostatic printing system, and the like.

### Description of the Related Art

In recent years, with the advancement of technologies of electrophotographic processes, there has been a demand for the development of a toner for electrophotography (toner for electrostatic image development) that supports high-image quality, and high speed and power saving. The demand toner characteristics include both a reduction in the particle size of the toner that supports the high-image quality, and separability (good hot-offset resistance) and a low fixing temperature (good low-temperature fixability) that support the high speed and power saving. From this point of view, a polyester obtained using an alkylene oxide adduct of bisphenol A as a raw material monomer is used as a binder resin for a toner (refer to Japanese Patent Laid-Open No. 2000-172008). From the viewpoint of improving low-temperature fixability, use of a crystalline polyester is disclosed (refer to Japanese Patent Laid-Open No. 2001-222138).

Meanwhile, in recent years, reuse and effective utilization of plastic products such as used PET bottles have become a major disadvantages, including environmental and resource disadvantages. As the number of PET bottles sold increases, an improvement in the recycling rate has been desired. The methods for recycling PET bottles include use in sheet applications such as trays for food, use in fiber applications such as clothing, and use of bottle-to-bottle, which is horizontal recycling.

Accordingly, also in the field of electrophotography, use of used PET bottles (so-called recycled PET), which are a polyester recovered from waste, has been proposed (refer to Japanese Patent Laid-Open No. 8-239409).

With reference to Japanese Patent Laid-Open Nos. 2000-172008 and 2001-222138, the inventors of the present disclosure have conducted studies on a toner produced by introducing a polyethylene terephthalate structure into an amorphous polyester obtained using an alkylene oxide adduct of bisphenol A, and using the resulting amorphous polyester in combination with a crystalline polyester. However, it has been found that, in high-speed apparatuses suitable for the printing market, there may be disadvantages in low-temperature fixability and separability between a fixed image and a fixing member. It is considered that the amorphous polyester in which the polyethylene terephthalate structure is introduced has low compatibility with the crystalline polyester due to high polarity of the polyethylene terephthalate structure, resulting in a decrease in low-temperature fixability. It is also considered that the amorphous polyester in which the polyethylene terephthalate structure is introduced has poor rigidity compared with the amorphous polyester obtained using only the alkylene oxide adduct of bisphenol A, resulting in a decrease in separability with respect to the fixing member.

Furthermore, when hydrocarbon wax, which has low polarity, is used as a release agent, compatibility of the hydrocarbon wax with the amorphous polyester having the polyethylene terephthalate structure decreases. Therefore, separability from the fixing member tends to further decrease.

The compatibility of the crystalline polyester with the amorphous polyester having the polyethylene terephthalate structure can be improved by increasing the polarity of the crystalline polyester; however, in such a case, separability may decrease due to an excessive decrease in the viscosity. In order to suppress this excessive decrease in the viscosity, a method of using, for example, a crosslinking agent or a metal element having a filler effect is conceivable; however, thermal contraction increases, which may cause curling of media, such as paper, after fixation to the media.

Accordingly, to provide a toner containing polyethylene terephthalate to a high-speed apparatus, there are still disadvantages in terms of low-temperature fixability, separability from a fixing member, and curling resistance for media.

### SUMMARY

The present disclosure provides a toner that exhibits good low-temperature fixability, separability from a fixing member, and curling resistance for media even in a high-speed apparatus suitable for the printing market.

The present disclosure relates to a toner including toner particles containing a binder resin and a release agent, wherein
the binder resin contains an amorphous resin A and a crystalline polyester C,
the amorphous resin A is a polyester and has, as a structure that forms a polyester backbone,
   (i) a polyethylene terephthalate structural moiety, and
   (ii) at least one structure selected from the group consisting of a unit represented by formula (1), a unit represented by formula (2), a unit represented by formula (3), and a unit represented by formula (4),

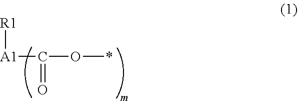

in formula (1), R¹ represents an alkyl group having 6 to 16 carbon atoms or an alkenyl group having 6 to 16 carbon atoms,
A1 represents a hydrocarbon group,
* represents a bonding site in the polyester backbone, and
m represents an integer of 2 or more;

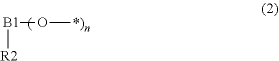

in formula (2), R2 represents an alkyl group having 6 to 16 carbon atoms or an alkenyl group having 6 to 16 carbon atoms,
B1 represents a hydrocarbon group,
* represents a bonding site in the polyester backbone, and
n represents an integer of 2 or more;

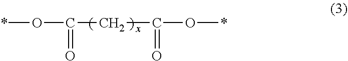

in formula (3), each * represents a bonding site in the polyester backbone, and x represents an integer of 6 to 16;

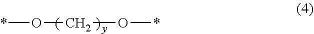

in formula (4), each * represents a bonding site in the polyester backbone, and
y represents an integer of 6 to 16;
an SP value of the amorphous resin A is represented by SP_{A} (cal/cm³)^{0.5}, an SP value of the crystalline polyester C is represented by SP_{C} (cal/cm³)^{0.5}, and SP_{A} and SP_{C} satisfy formula (C);

$$1. \leq {SP}_{A} - {SP}_{C} \leq 1.35 ; \qquad ( C )$$

the toner contains at least one metal element selected from the group consisting of calcium, magnesium, sodium, and barium and contains aluminum.

Further features of the present disclosure will become apparent from the following description of exemplary embodiments.

### DESCRIPTION OF THE EMBODIMENTS

Hereinafter, the present disclosure will be described in detail. The present disclosure is not limited to the descriptions below. In the present disclosure, the expression “XX or more and YY or less” or “XX to YY” indicating a numerical range means a numerical range including the lower limit and the upper limit, which are end points, unless otherwise specified. When numerical ranges are described in stages, the upper limits and the lower limits of the numerical ranges can be appropriately combined. The term “monomer unit” refers to a reacted form of a monomer substance in a polymer. The term “crystalline polyester” refers to a polyester that exhibits a distinct endothermic peak in differential scanning calorimetry (DSC).

A toner according to the present disclosure is
a toner including toner particles containing a binder resin and a release agent, in which
the binder resin contains an amorphous resin A and a crystalline polyester C,
the amorphous resin A is a polyester and has, as a structure that forms a polyester backbone,
   (i) a polyethylene terephthalate structural moiety, and
   (ii) at least one structure selected from the group consisting of a unit represented by formula (1), a unit represented by formula (2), a unit represented by formula (3), and a unit represented by formula (4),

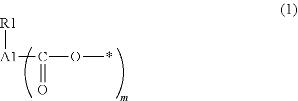

in formula (1), R1 represents an alkyl group having 6 to 16 carbon atoms or an alkenyl group having 6 to 16 carbon atoms,
A1 represents a hydrocarbon group,
* represents a bonding site in the polyester backbone, and
m represents an integer of 2 or more;

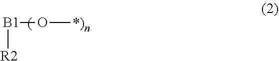

in formula (2), R2 represents an alkyl group having 6 to 16 carbon atoms or an alkenyl group having 6 to 16 carbon atoms,
B1 represents a hydrocarbon group,
* represents a bonding site in the polyester backbone, and
n represents an integer of 2 or more;

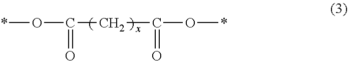

in formula (3), each * represents a bonding site in the polyester backbone, and
x represents an integer of 6 to 16;

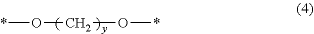

in formula (4), each * represents a bonding site in the polyester backbone, and
y represents an integer of 6 to 16;
an SP value of the amorphous resin A is represented by SP_{A} (cal/cm³) 0.5, an SP value of the crystalline polyester C is represented by SP_{C} (cal/cm³) 0.5, and SP_{A} and SP_{C} satisfy formula (C);

$$1. \leq {SP}_{A} - {SP}_{C} \leq 1.35 ; \qquad ( C )$$

the toner contains at least one metal element selected from the group consisting of calcium, magnesium, sodium, and barium and contains aluminum.

The inventors have conducted studies on a toner that contains a polyethylene terephthalate structure and that combines low-temperature fixability and separability and achieves curling resistance in a high-speed apparatus.

First, the inventors have conducted studies in order to improve dispersibility of a release agent into a toner that contains a polyethylene terephthalate structure.

As a result, it has been found that when an amorphous resin contains a polyester (amorphous resin A) having
(i) a polyethylene terephthalate structural moiety, and
(ii) at least one structure selected from the group consisting of a unit
   represented by formula (1), a unit represented by formula (2), a unit represented by formula (3), and a unit represented by formula (4), good separability with respect to a fixing member is achieved.

With the above configuration, the ethylene glycol (hereinafter, also referred to as EG) unit in the polyethylene terephthalate structure having high polarity improves a bleeding effect of a release agent. In addition, the presence of a long-chain hydrocarbon group such as an alkyl group or an alkenyl group included in the unit represented by formula (1), the unit represented by formula (2), the unit represented by formula (3), and the unit represented by formula (4) in the resin improves affinity between the amorphous resin and the release agent to improve dispersibility of the release agent. Due to these configurations, the bleeding effect of the release agent and dispersibility of the release agent are combined to improve the separability between the toner and the fixing member during fixing.

Next, the inventors have conducted studies in order to improve compatibility between the amorphous resin A and the crystalline polyester. As a result, it has been found to be important that when an SP value of the amorphous resin A is represented by SP_{A} (cal/cm³) 0.5 and an SP value of the crystalline polyester C is represented by SP_{C} (cal/cm³) 0.5, SP_{A} and SP_{C} satisfy formula (C). When the SP values of the amorphous resin A and the crystalline polyester C are within the range of formula (C), low-temperature fixability is improved by the plasticizing effect of the crystalline polyester. When the difference between SP_{A} and SP_{C} is 1.35 or less, at high temperature, the amorphous resin A and the crystalline polyester C are compatible with each other, and low-temperature fixability is thereby improved. When the difference between SP_{A} and SP_{C} is 1.00 or more, presumably, an excessive decrease in the viscosity of the toner in a molten state is suppressed, and separability from the fixing member is improved.

However, in the evaluation of a toner having the above-described resin configurations using a high-speed apparatus suitable for the printing market, it has been found that separability between the toner and the fixing member is insufficient. In view of this, the inventors have further conducted studies and found to be important that the toner having the above resin configurations contain at least one metal element selected from the group consisting of calcium, magnesium, sodium, and barium and contain aluminum. The inventors infer that the reason why the above configurations can achieve both low-temperature fixability and separability and realize curling resistance even in a high-speed apparatus suitable for the printing market is as follows.

As described above, since the polyethylene terephthalate structural moiety has a structure derived from EG (hereinafter, also referred to as an ethylene glycol-derived structure), the viscoelasticity is likely to excessively decrease during fixing. As in the related art, a method of addressing this disadvantage using a crosslinking agent, a metal element having a filler effect, or the like is conceivable; however, thermal contraction increases, resulting in a decrease in curling resistance.

That is, there is a trade-off relationship between separability and curling resistance. Since the amorphous resin A contains the polyethylene terephthalate structural moiety, the amorphous resin A has a repeating structure of a condensate of terephthalic acid and EG in the polyester backbone. Therefore, a structure derived from EG, which has high polarity, is localized in the resin, and a weak interaction occurs between the localized structure derived from EG and the metal element.

Aluminum element, which has a valence of +3, interacts with the structure derived from EG to form a three-dimensional cross-liked structure between resins, and thus can provide the toner with appropriate elasticity. Metal atoms having a valence of +1 or +2, such as calcium, magnesium, sodium, and barium cause a one-dimensional or two-dimensional interaction with the structure derived from EG. Accordingly, since extensibility is provided in any direction in a high-temperature state during fixing, a structure that is less likely to undergo excessive thermal contraction is formed in a cooling process after fixing. As described above, the synergistic effect of the one-dimensional, two-dimensional, and three-dimensional interactions between the polyethylene terephthalate structural moiety and the above metal elements and aluminum can suppress the decrease in the viscoelasticity during fixing and excessive thermal contraction after fixing.

In the present disclosure, a ratio M/A of a total content M (mmol/kg) of calcium, magnesium, sodium, and barium in the toner to a content A (mmol/kg) of aluminum in the toner preferably satisfies formula (D) below.

$$1. \leq M / A \leq 1 0. \qquad ( D )$$

It is considered that when M/A is 1.0 or more, excessive thermal contraction after fixing is effectively suppressed, and curling resistance is further improved, and when M/A is 10.0 or less, an excessive decrease in the viscosity during fixing is suppressed, and separability from a fixing member is further improved.

Furthermore, M is preferably 5.0 mmol/kg or more and 50.0 mmol/kg or less, and A is preferably 0.5 mmol/kg or more and 50.0 mmol/kg or less. It is considered that when M and A are within the above ranges, the synergistic effect of the one-dimensional, two-dimensional, and three-dimensional interactions further improves curling resistance and separability from a fixing member.

A ratio WEG (% by mole) of an ethylene glycol-derived structure to a total number of moles of an alcohol-derived structure and a carboxylic acid-derived structure forming the polyester backbone in the amorphous resin A preferably satisfies formula (E) below. Note that WEG (% by mole) is a ratio of an ethylene glycol-derived structure of the polyethylene terephthalate structural moiety to a total number of moles of an alcohol-derived structure and a carboxylic acid-derived structure forming the polyester backbone in the amorphous resin A. In the calculation of WEG (% by mole), the polyethylene terephthalate moiety is separated into a unit derived from ethylene glycol and a unit derived from terephthalic acid to deal with the number of moles.

$$12.6 \leq {W}_{EG} \leq 24.8 \qquad ( E )$$

It is considered that when WEG is 12.6% by mole or more, the ratio of the high-polarity structure derived from EG in polyethylene terephthalate present in the toner is increased, and a larger bleeding effect of the release agent is obtained. Similarly, it is considered that when WEG is 24.8% by mole or less, the compatibility between the amorphous resin A and the crystalline polyester C is enhanced, and a larger effect of low-temperature fixability is thereby obtained.

In the present disclosure, a proportion WCH (% by mole) of at least one structure selected from the group consisting of the unit represented by formula (1), the unit represented by formula (2), the unit represented by formula (3), and the unit represented by formula (4) in the polyester in the amorphous resin A preferably satisfies formula (F) below. Note that WCH (% by mole) is a ratio of a total of the unit represented by formula (1), the unit represented by formula (2), the unit represented by formula (3), and the unit represented by formula (4) to the total number of moles of an alcohol-derived structure and a carboxylic acid-derived structure forming the polyester backbone in the amorphous resin A. In the calculation of WCH (% by mole), the polyethylene terephthalate moiety is separated into a unit derived from ethylene glycol and a unit derived from terephthalic acid to deal with the number of moles.

$$5.6 \leq {W}_{CH} \leq 14. 6 \qquad ( F )$$

It is considered that when WCH is 5.6% by mole or more, the affinity with the release agent becomes higher, and dispersibility is thereby improved. It is considered that when WCH is 14.6% by mole or less, an excessive decrease in the viscoelasticity during toner melting is further suppressed, and thus separability from a fixing member is improved.

Moreover, in the present disclosure, a glass transition temperature of the amorphous resin A is represented by Tg_{A} (° C.), and Tg_{A} preferably satisfies formula (G) below.

$$40. \leq {Tg}_{A} \leq 5 5. \qquad ( G )$$

It is considered that when Tg_{A} is 40.0° C. or higher, an excessive decrease in the viscoelasticity is further suppressed, and thus separability with respect to a fixing member is improved. It is considered that when Tg_{A} is 55.0° C. or lower, the affinity with the release agent becomes higher, and thus dispersibility of the release agent is improved.

The crystalline polyester C may be a modified crystalline polyester having a structure in which a hydroxy group at a terminal of the main chain is terminally modified with an aliphatic monocarboxylic acid having 16 to 31 carbon atoms or a modified crystalline polyester having a structure in which a carboxy group at a terminal of the main chain is terminally modified with an aliphatic monoalcohol having 15 to 30 carbon atoms. When a terminal of the main chain of the crystalline polyester C has a number of carbon atoms close to double that of the long-chain hydrocarbon group, such as an alkyl group or an alkenyl group, contained in the amorphous resin A, the interaction with the release agent is further enhanced. It is considered that, as a result, charge leakage due to molecular mobility can be reduced.

Furthermore, a ratio MAIM/EGM of a total number of moles MAIM of the metal elements selected from the group of the metal elements and aluminum to the number of moles EGM of the structure derived from EG in the amorphous resin A is preferably 1.0×10⁻⁴ to 1.0×10⁺¹. When the ratio is 1.0×10⁻⁴ or more, a larger effect of the interaction with the structural moiety derived from ethylene glycol is obtained. When the ratio is 1.0×10⁺¹ or less, the effects are particularly large in terms of low-temperature fixability, separability, and curling resistance.

Specifically, EGM (mmol/kg) is the content of the structure derived from ethylene glycol in the amorphous resin A, and MAIM (mmol/kg) is the total content of calcium, magnesium, sodium, barium, and aluminum in the toner. Note that EGM (mmol/kg) is the molar concentration of the structure derived from ethylene glycol of the polyethylene terephthalate structural moiety contained in the amorphous resin A. In the calculation of EGM (mmol/kg), the polyethylene terephthalate moiety is separated into a unit derived from ethylene glycol and a unit derived from terephthalic acid to deal with the number of moles.

The content of the structure derived from ethylene glycol in the amorphous resin A contained in the toner is represented by MEG (mmol/kg), and a ratio MAIM/MEG of MAIM to MEG is preferably 0.80×10⁻² to 2.00×10⁻¹. Note that MEG (mmol/kg) is the molar concentration of the structure derived from ethylene glycol of the polyethylene terephthalate structural moiety in the amorphous resin A based on the mass of the toner. In the calculation of MEG (mmol/kg), the polyethylene terephthalate moiety is separated into a unit derived from ethylene glycol and a unit derived from terephthalic acid to deal with the number of moles.

When MAIM/MEG is 0.80×10⁻² or more, a larger effect of the interaction between the polyethylene terephthalate structural moiety and the metal elements is obtained. When MAIM/MEG is 2.00×10⁻¹ or less, the effects are particularly large in terms of low-temperature fixability, separability, and curling resistance.

Hereinafter, embodiments of the amorphous resin A, the crystalline polyester C, the release agent, and other components that can be used in the present disclosure will be specifically described.

Amorphous resin A

The amorphous resin A is a polyester and has, as a structure that forms a polyester backbone, (i) and (ii) below:
(i) a polyethylene terephthalate structural moiety
(ii) at least one structure selected from the group consisting of a unit represented by formula (1), a unit represented by formula (2), a unit represented by formula (3), and a unit represented by formula (4)

The polyethylene terephthalate structure used in the amorphous resin A is obtained by polycondensation of ethylene glycol and terephthalic acid.

The synthesis of the polyester can be conducted in an inert gas atmosphere, preferably in the presence of an esterification catalyst, and optionally, in the presence of an esterification promoter, a polymerization inhibitor, etc. preferably at a temperature of about 180° C. or higher and about 250° C. or lower.

Examples of esterification catalysts include tin compounds such as dibutyltin oxide and tin (II) 2-ethylhexanoate; and titanium compounds such as titanium diisopropylate bistriethanolaminate. Of these, a tin compound such as tin (II) 2-ethylhexanoate is preferred.

The amount of esterification catalyst used is preferably 0.01 parts by mass or more, more preferably 0.1 parts by mass or more, and preferably 1.5 parts by mass or less, more preferably 1.0 part by mass or less relative to 100 parts by mass of raw material monomers (an alcohol component, a carboxylic acid component, and PET). Examples of esterification promoters include gallic acid. The amount of esterification promoter used is preferably 0.001 parts by mass or more, more preferably 0.01 parts by mass or more, and preferably 0.5 parts by mass or less, more preferably 0.1 parts by mass or less relative to 100 parts by mass of the raw material monomers. Examples of polymerization inhibitors include tert-butyl catechol. The amount of polymerization inhibitor used is preferably 0.001 parts by mass or more, more preferably 0.01 parts by mass or more, and preferably 0.5 parts by mass or less, more preferably 0.1 parts by mass or less relative to 100 parts by mass of the raw material monomers.

In the synthesis of the polyester, polyethylene terephthalate may be present from the start of the condensation polymerization reaction or may be added to the reaction system in the middle of the condensation polymerization reaction. In order that the polyethylene terephthalate structural moiety is incorporated into the main backbone of the polyester in a block shape to a certain degree, the timing of addition of polyethylene terephthalate is preferably at a stage at which the reaction rate of the alcohol component and the carboxylic acid component is 10% or less, more preferably 5% or less. Herein, the reaction rate refers to a value represented by the following formula:

$$Amount of produced reaction water ( mol ) / amount of water produced ( mol ) in the case where all components are assumed to have reacted \times 100$$

The polyethylene terephthalate structural moiety contained in the amorphous resin A may be a repeating structure of a condensate of terephthalic acid and EG, represented by formula (5) below. In formula (5), p is preferably 3 or more and 10 or less, more preferably 4 or more and 8 or less. Within this range, the structure derived from EG included in the polyethylene terephthalate structural moiety contained in the amorphous resin A is more suitably localized to provide a larger effect of the interaction between the polyethylene terephthalate structural moiety and the metal elements.

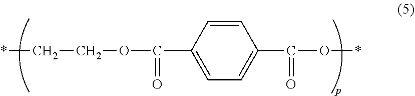

(In formula (5), * represents a bonding site in the polyester backbone, and p represents an integer of 3 to 10.)

The polyethylene terephthalate structural moiety contained in the amorphous resin A may be derived from used polyethylene terephthalate (so-called recycled PET). Reusing polyethylene terephthalate is preferable from an environmental perspective.

Used PET is collected, and the collected PET is washed, sorted so as to avoid mixing with other materials and dust. After labels and the like are removed, the PET is crushed into flakes or the like. The crushed product can be used as it is, or a product obtained by kneading the crushed product and then roughly crushing the kneaded product can also be used. If chemical substances adsorbed on the surfaces of PET bottles cannot be sufficiently removed by usual washing, alkali washing may be performed. If part of the crushed product is hydrolyzed by alkali washing, in order to recover the decreased degree of polymerization, the washed crushed product may be melted and pelletized, and the resulting pellets may be subjected to solid-phase polymerization. The solid-phase polymerization step can be performed by subjecting washed flakes or pellets obtained by melt-extruding the flakes and pelletizing the extruded product to continuous solid-phase polymerization in an inert gas such as nitrogen gas, a rare gas, or the like at 180° C. to 245° C., preferably 200° C. to 240° C. Alternatively, a product obtained by degrading a washed crushed product into monomer units by depolymerization and subjected to resynthesis may be used.

The recycled PET is not limited to the used PET described above, and off-spec PET fiber waste or pellets discharged from factories may be used.

In order to incorporate at least one unit selected from the group consisting of the unit represented by formula (1), the unit represented by formula (2), the unit represented by formula (3), and the unit represented by formula (4) into the amorphous resin A, the following monomers can be used.

Examples thereof include 1,6-hexanediol, 1,7-heptanediol, 1,8-octanediol, 1,9-nonanediol, 1,10-decanediol, 1,11-undecanediol, 1,12-dodecanediol, suberic acid, azelaic acid, sebacic acid, undecanedioic acid, dodecanedioic acid, hexadecanedioic acid, octadecanedioic acid, dodecenylsuccinic acid, n-octylsuccinic acid, isododecenylsuccinic acid, dodecylsuccinic acid, isooctenylsuccinic acid, and hexadecylsuccinic acid.

Among the unit represented by formula (1), the unit represented by formula (2), the unit represented by formula (3), and the unit represented by formula (4), the unit represented by formula (1) and the unit represented by formula (2) are preferred. Since an alkyl group or alkenyl group having 6 to 16 carbon atoms is branched from the main chain of the polyester backbone, affinity with the release agent is increased, and dispersibility of the release agent is further improved.

As the components for obtaining the amorphous resin A, besides the structures and monomers described above, other polyhydric alcohols (dihydric or higher alcohols), polycarboxylic acids (divalent or higher carboxylic acids), acid anhydrides thereof, or lower alkyl esters thereof may be used.

The following polyhydric alcohol monomers can be used as polyhydric alcohol monomers. Examples of dihydric alcohol components include ethylene glycol, propylene glycol, 1,3-butanediol, 1,4-butanediol, 2,3-butanediol, diethylene glycol, triethylene glycol, neopentyl glycol, 2-ethyl-1,3-hexanediol, hydrogenated bisphenol A, bisphenol and derivatives thereof represented by formula (A);

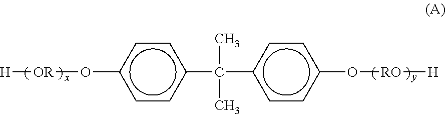

where each R represents an ethylene or propylene group, x and y are each an integer of 0 or more, and the average of x+y is 0 or more and 10 or less; and
diols represented by formula (B);

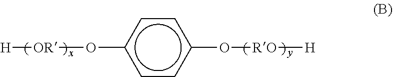

where each R′ represents —CH₂—CH₂—, —CH₂—CH(—CH₃)—, or —CH₂—C(—CH₃)₂—, x′ and y′ are each an integer of 0 or more, and the average of x′+y′ is 0 or more and 10 or less.

Examples of trihydric or higher alcohol components include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. Of these, glycerol, trimethylolpropane, and pentaerythritol are preferably used.

These dihydric alcohols and trihydric or higher alcohols may be used alone or in combination of two or more thereof.

Examples of divalent carboxylic acid components include maleic acid, fumaric acid, citraconic acid, itaconic acid, glutaconic acid, phthalic acid, isophthalic acid, terephthalic acid, succinic acid, azelaic acid, malonic acid, anhydrides of these acids, and lower alkyl esters thereof. Of these, maleic acid, fumaric acid, and terephthalic acid are preferably used.

Examples of trivalent or higher carboxylic acids, acid anhydrides thereof, and lower alkyl esters thereof include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl) methane, 1,2,7,8-octanetetracarboxylic acid, pyromellitic acid, empol trimer acid, acid anhydrides thereof, and lower alkyl esters thereof. Of these, in particular, 1,2,4-benzenetricarboxylic acid, i.e., trimellitic acid, or a derivative thereof is preferably used because it is inexpensive and the reaction control is easy. These divalent carboxylic acids and the like and trivalent or higher carboxylic acids may be used alone or in combination of two or more thereof.

The method for producing the amorphous resin A is not particularly limited, and a known method can be employed. For example, the alcohol monomer and the carboxylic acid monomer described above are charged at the same time and polymerized through an esterification reaction or a transesterification reaction, and a condensation reaction to produce a polyester. The polymerization temperature is not particularly limited and is preferably 180° C. or higher and 290° C. or lower. In the polymerization of the polyester unit, a polymerization catalyst such as a titanium-based catalyst, a tin-based catalyst, zinc acetate, antimony trioxide, or germanium dioxide can be used.

In particular, the amorphous resin A may be a polyester polymerized using a tin-based catalyst.

The amorphous resin A may be a polyester having a vinyl resin moiety. The method for obtaining a polyester to which a vinyl resin is bonded may be a method using a monomer component that can react with both a vinyl resin and a polyester moiety. Such a monomer may be a monomer having an unsaturated double bond and a carboxy group or a hydroxy group. Examples thereof include unsaturated dicarboxylic acids such as phthalic acid, maleic acid, citraconic acid, itaconic acid, anhydrides thereof, acrylates, and methacrylates.

The peak molecular weight of the amorphous resin A according to the present disclosure is preferably 3,500 or more and 20,000 or less from the viewpoint of, for example, low-temperature fixability. The glass transition temperature is preferably 40° C. to 70° C.

In addition to the amorphous resin A, various resins known as binder resins in the related art can be used as amorphous resins in combination. Examples of such resins include phenolic resins, natural resin-modified phenolic resins, natural resin-modified maleic resins, acrylic resins, methacrylic resins, polyvinyl acetate resins, silicone resins, polyester resins, polyurethanes, polyamide resins, furan resins, epoxy resins, xylene resins, polyvinyl butyral, terpene resins, coumarone-indene resins, and petroleum-based resins.

At least one metal element selected from the group consisting of calcium, magnesium, sodium, and barium and aluminum element

The toner according to the present disclosure contains aluminum and at least one metal element selected from the group consisting of calcium, magnesium, sodium, and barium. As for the method for incorporating the above elements in the toner, in the case where the toner is produced by a melt-kneading method, a method of kneading a component containing the above metal elements together with the resins may be employed. In the case where the toner is produced by a phase-inversion emulsification method, a method in which the above metal elements are incorporated as an aggregating agent may be employed. In the case where the toner is produced by a polymerization method, a method in which the above metal elements are used as a catalyst may be employed.

Examples of components containing metal elements include inorganic metal salts and inorganic metal salt polymers. Examples of metal salts of the above metal elements include sodium sulfate, sodium nitrate, calcium chloride, calcium nitrate, barium chloride, magnesium chloride, sodium chloride, calcium polysulfide, aluminum chloride, and aluminum sulfate. Examples of inorganic metal salt polymers include polyaluminum chloride and polyaluminum hydroxide.

Crystalline polyester C

As monomers used in the polyester unit of the crystalline polyester C used in the toner according to the present disclosure, a polyhydric alcohol (dihydric or trihydric or higher alcohol) and a polycarboxylic acid (divalent or trivalent or higher carboxylic acid), an acid anhydride thereof, or a lower alkyl ester thereof are used.

The polyhydric alcohol monomer used in the polyester unit of the crystalline polyester C may be any of polyhydric alcohol monomers below.

The polyhydric alcohol monomer is not particularly limited, and may be a chain (in particular, linear) aliphatic diol. Examples thereof include ethylene glycol, diethylene glycol, triethylene glycol, 1,2-propylene glycol, 1,3-propylene glycol, dipropylene glycol, 1,4-butanediol, 1,4-butanediene glycol, trimethylene glycol, tetramethylene glycol, pentamethylene glycol, hexamethylene glycol, octamethylene glycol, nonamethylene glycol, decamethylene glycol, and neopentyl glycol. Of these, linear aliphatic a,@-diols such as ethylene glycol, diethylene glycol, 1,4-butanediol, and 1,6-hexanediol can be particularly used.

In the present disclosure, polyhydric alcohol monomers other than the above polyhydric alcohols may be used. Examples of dihydric alcohol monomers among the polyhydric alcohol monomers include aromatic alcohols, such as polyoxyethylenated bisphenol A and polyoxypropylenated bisphenol A; and 1,4-cyclohexanedimethanol. Examples of trihydric or higher alcohol monomers among the polyhydric alcohol monomers include aromatic alcohols such as 1,3,5-trihydroxymethylbenzene; and aliphatic alcohols such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, and trimethylolpropane.

The polycarboxylic acid monomer used in the polyester unit of the crystalline polyester C may be any of polycarboxylic acid monomers below.

The polycarboxylic acid monomer is not particularly limited, and may be a chain (in particular, linear) aliphatic dicarboxylic acid. Specific examples thereof include oxalic acid, malonic acid, succinic acid, glutaric acid, adipic acid, pimelic acid, suberic acid, glutaconic acid, azelaic acid, sebacic acid, nonanedicarboxylic acid, decanedicarboxylic acid, undecanedicarboxylic acid, dodecanedicarboxylic acid, maleic acid, fumaric acid, mesaconic acid, citraconic acid, and itaconic acid. Acid anhydrides thereof, hydrolysates of lower alkyl esters thereof, etc. are also included.

In the present disclosure, polycarboxylic acids other than the above polycarboxylic acid monomers may be used. Examples of divalent carboxylic acids among other polycarboxylic acid monomers include aromatic carboxylic acids such as isophthalic acid and terephthalic acid; aliphatic carboxylic acids such as n-dodecylsuccinic acid and n-dodecenylsuccinic acid; and alicyclic carboxylic acids such as cyclohexanedicarboxylic acid. Acid anhydrides thereof, lower alkyl esters thereof, etc. are also included. Examples of trivalent or higher carboxylic acids among other carboxylic acid monomers include aromatic carboxylic acids such as 1,2,4-benzenetricarboxylic acid (trimellitic acid), 2,5,7-naphthalenetricarboxylic acid, 1,2,4-naphthalenetricarboxylic acid, and pyromellitic acid; and aliphatic carboxylic acids such as 1,2,4-butanetricarboxylic acid, 1,2,5-hexanetricarboxylic acid, and 1,3-dicarboxyl-2-methyl-2-methylenecarboxypropane. Derivatives such as acid anhydrides thereof and lower alkyl esters thereof are also included.

The crystalline polyester C may be a modified crystalline polyester having a structure in which a hydroxy group at a terminal of the main chain is terminally modified with an aliphatic monocarboxylic acid having 16 to 31 carbon atoms or a modified crystalline polyester having a structure in which a carboxy group at a terminal of the main chain is terminally modified with an aliphatic monoalcohol having 15 to 30 carbon atoms.

Examples of aliphatic monocarboxylic acid monomers having 16 to 31 carbon atoms include palmitic acid (hexadecanoic acid), margaric acid (heptadecanoic acid), stearic acid (octadecanoic acid), nonadecylic acid, arachidic acid (icosanoic acid), heneicosanoic acid, docosanoic acid, tetracosanoic acid, hexacosanoic acid, octacosanoic acid, and triacontanoic acid.

Examples of aliphatic monoalcohols having 15 to 30 carbon atoms include cetyl alcohol, palmityl alcohol (hexadecanol), margaryl alcohol (heptadecanol), stearyl alcohol (octadecanol), nonadecanol, arachidyl alcohol (icosanol), heneicosanol, behenyl alcohol, lignoceryl alcohol, ceryl alcohol, 1-heptacosanol, montanyl alcohol, 1-nonacosanol, and myricyl alcohol.

In the toner according to the present disclosure, the crystalline polyester C is preferably used in an amount of 3 parts by mass or more and 20 parts by mass or less per 100 parts by mass of the amorphous resin in view of low-temperature fixability, abrasion resistance, and a charge retention ability in high-temperature, high-humidity environments.

The crystalline polyester C can be produced in accordance with a typical polyester synthesis method.

For example, a crystalline polyester can be obtained by subjecting the carboxylic acid monomer and the alcohol monomer to an esterification reaction or a transesterification reaction, and then causing a polycondensation reaction under reduced pressure or by introducing nitrogen gas according to an ordinary method. Subsequently, the above-described aliphatic compound is further added and an esterification reaction is performed. Thus, a desired crystalline polyester can be provided.

The esterification reaction or the transesterification reaction can be performed using a typical esterification catalyst or transesterification catalyst such as titanium butoxide, dibutyltin oxide, manganese acetate, or magnesium acetate, as needed.

The polycondensation reaction can be performed using a typical polymerization catalyst, such as known catalysts, e.g., titanium butoxide, dibutyltin oxide, tin acetate, zinc acetate, tin disulfide, antimony trioxide, or germanium dioxide. The polymerization temperature and the amount of catalyst are not particularly limited and may be appropriately determined.

In the esterification or transesterification reaction or the polycondensation reaction, a method in which all the monomers are charged at once may be employed in order to increase the strength of the crystalline polyester to be obtained. Alternatively, for example, a method in which a divalent monomer is first caused to react, and a trivalent or higher monomer is then added and caused to react may be employed in order to reduce a low-molecular-weight component.

The melting point of the crystalline polyester C is preferably 70° C. to 110° C., more preferably 80° C. to 100° C. in view of low-temperature fixability. In the toner according to the present disclosure, the crystalline polyester C is preferably used in an amount of 3 parts by mass or more and 20 parts by mass or less per 100 parts by mass of the amorphous resin in view of low-temperature fixability, abrasion resistance, and charge retention ability in high-temperature, high-humidity environments.

### Release Agent

As the release agent, a material that can be crystallized and that has an exothermic peak in differential scanning calorimetry (DSC) can be used. Examples of the release agent include the following: hydrocarbon waxes, such as low-molecular-weight polyethylene, low-molecular-weight polypropylene, alkylene copolymers, microcrystalline wax, paraffin wax, and Fischer-Tropsch wax; oxides of hydrocarbon waxes, such as polyethylene oxide wax, and block copolymers thereof; waxes whose main component is a fatty acid ester, such as carnauba wax; partially or wholly deoxidized fatty acid esters, such as deoxidized carnauba wax; saturated linear fatty acids, such as palmitic acid, stearic acid, and montanic acid; unsaturated fatty acids, such as brassidic acid, eleostearic acid, and parinaric acid; saturated alcohols, such as stearyl alcohol, aralkyl alcohol, behenyl alcohol, carnaubyl alcohol, ceryl alcohol, and melissyl alcohol; polyhydric alcohols, such as sorbitol; esters of a fatty acid, such as palmitic acid, stearic acid, behenic acid, or montanic acid, and an alcohol, such as stearyl alcohol, aralkyl alcohol, behenyl alcohol, carnaubyl alcohol, ceryl alcohol, or melissyl alcohol; fatty acid amides, such as linoleic acid amide, oleic acid amide, and lauric acid amide; saturated fatty acid bisamides such as methylene-bis-stearic acid amide, ethylene-bis-capric acid amide, ethylene-bis-lauric acid amide, and hexamethylene-bis-stearic acid amide; unsaturated fatty acid amides, such as ethylene-bis-oleic acid amide, hexamethylene-bis-oleic acid amide, N,N′-dioleyl adipic acid amide, and N,N′-dioleyl sebacic acid amide; aromatic bisamides, such as m-xylene bis-stearic acid amide and N,N′-distearyl isophthalic acid amide; fatty acid metal salts (generally referred to as metal soap), such as calcium stearate, calcium laurate, zinc laurate, and magnesium stearate; waxes prepared by grafting an aliphatic hydrocarbon wax with a vinyl monomer, such as styrene or acrylic acid; partially esterified products of a fatty acid and a polyhydric alcohol, such as behenic acid monoglyceride; and methyl ester compounds having a hydroxyl group obtained by hydrogenation of vegetable fat and oil.

Of these release agents, hydrocarbon waxes such as paraffin wax and Fischer-Tropsch wax can be used in terms of abrasion resistance.

The exothermic peak temperature of the release agent during temperature drop measurement in differential scanning calorimetry (DSC) is preferably 70° C. to 120° C. in view of low-temperature fixability and separability. The release agent is preferably used in an amount of 3 parts by mass or more and 20 parts by mass or less per 100 parts by mass of the amorphous resin in view of separability and a charge retention ability in high-temperature, high-humidity environments.

### Colorant

The toner according to the present disclosure may contain a colorant as needed. Examples of colorants include the following.

Examples of a black colorant include carbon black; and colorants adjusted to black using a yellow colorant, a magenta colorant, and a cyan colorant. As the colorant, a pigment may be used alone, or a dye and a pigment may be used in combination. In view of the image quality of full-color images, a dye and a pigment can be used in combination.

Examples of pigments for a magenta toner include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; and C.I. Vat Red 1, 2, 10, 13, 15, 23, 29, and 35.

Examples of dyes for a magenta toner include oil-soluble dyes such as C.I. Solvent Red 1, 3, 8, 23, 24, 25, 27, 30, 49, 81, 82, 83, 84, 100, 109, and 121; C.I. Disperse Red 9; C.I. Solvent Violet 8, 13, 14, 21, and 27; and C.I. Disperse Violet 1; and basic dyes such as C.I. Basic Red 1, 2, 9, 12, 13, 14, 15, 17, 18, 22, 23, 24, 27, 29, 32, 34, 35, 36, 37, 38, 39, and 40; C.I. Basic Violet 1, 3, 7, 10, 14, 15, 21, 25, 26, 27, and 28.

Examples of pigments for a cyan toner include C.I. Pigment Blue 2, 3, 15:2, 15:3, 15:4, 16, and 17; C.I. Vat Blue 6; C.I. Acid Blue 45; and copper phthalocyanine pigments having a phthalocyanine skeleton substituted with 1 to 5 phthalimidomethyl groups.

Examples of dyes for a cyan toner include C.I. Solvent Blue 70.

Examples of pigments for a yellow toner include C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellow 1, 3, and 20.

Examples of dyes for a yellow toner include C.I. Solvent Yellow 162.

These colorants can be used alone, in combination as a mixture, or in the form of a solid solution.

Such a colorant is selected in accordance with the hue angle, color saturation, lightness value, light fastness, OHP transparency, and dispersibility in the toner. The content of the colorant is preferably 0.1 parts by mass to 30.0 parts by mass relative to 100 parts by mass of the binder resin.

### Charge Control Agent

The toner according to the present disclosure may contain a charge control agent as needed. Incorporation of the charge control agent enables charge characteristics to be stabilized and enables an optimal triboelectric charging amount to be controlled according to the developing system.

Known charge control agents can be used. In particular, a metal compound of an aromatic carboxylic acid, which is colorless, has a high toner charging speed, and can stably maintain a constant charge amount, may be used.

Examples of negative charge control agents include salicylic acid metal compounds, naphthoic acid metal compounds, dicarboxylic acid metal compounds, polymer compounds having sulfonic acid or carboxylic acid in a side chain, polymer compounds having a sulfonate or esterified sulfonic acid in a side chain, polymer compounds having a carboxylate or esterified carboxylic acid in a side chain, boron compounds, urea compounds, silicon compounds, and calixarenes.

The charge control agent may be internally added or externally added to the toner particles. The content of the charge control agent is preferably 0.2 parts by mass to 10.0 parts by mass, more preferably 0.5 parts by mass to 10.0 parts by mass relative to 100 parts by mass of the binder resin.

### Inorganic Fine Particles

The toner according to the present disclosure may contain inorganic fine particles as needed.

The inorganic fine particles may be internally added to the toner particles or may be mixed with the toner particles as an external additive. Examples of inorganic fine particles include fine particles, such as fine silica particles, fine titanium oxide particles, fine alumina particles, and fine particles of their complex oxides. Among the inorganic fine particles, fine silica particles and fine titanium oxide particles can be used for improving the flowability and uniformizing the charge.

The inorganic fine particles may be hydrophobized with a hydrophobizing agent such as a silane compound, a silicone oil, or a mixture thereof.

### External Additive

Besides the inorganic fine particles described above, organic fine particles such as fine melamine-based resin particles and fine polytetrafluoroethylene resin particles may be used as an external additive.

From the viewpoint of improving flowability, the median diameter (D50) of the external additive is, on a number basis, preferably 10 nm or more and is preferably 250 nm or less, more preferably 200 nm or less, still more preferably 90 nm or less. The content of the external additive is preferably 0.1 parts by mass to 10.0 parts by mass relative to 100 parts by mass of the toner particles. The toner particles and the external additive can be mixed using a known mixer such as a Henschel Mixer.

### Developer

The toner according to the present disclosure may be used as a one-component developer or, in order to further improve dot reproducibility or provide stable images for a long term, may be mixed with a magnetic carrier and used as a two-component developer.

Examples of the magnetic carrier include commonly known magnetic carriers such as iron oxide; metal particles such as particles of iron, lithium, calcium, magnesium, nickel, copper, zinc, cobalt, manganese, chromium, strontium, and rare earth elements, particles of alloys thereof, and particles of oxides thereof; magnetic materials such as ferrite and magnetite; and a magnetic material-dispersed resin carrier (so-called resin carrier) containing a magnetic material and a binder resin that holds the magnetic material in a dispersed state, and a magnetic carrier in the form of ferrite or magnetite particles that have pores filled with a resin.

As the magnetic carrier, the above magnetic material may be directly used or a magnetic material including the above magnetic material as a core and a resin covering the surface of the core may be used. From the viewpoint of improving chargeability of the toner, a magnetic material including the above magnetic material as a core and a resin covering the surface of the core may be used as the magnetic carrier.

The resin covering the core is not particularly limited, and a known resin can be selected and used as long as toner characteristics are not impaired. A resin such as a (meth)acrylic resin, a silicone resin, a urethane resin, polyethylene, polyethylene terephthalate, polystyrene, or a phenolic resin, or a copolymer or polymer mixture containing these can be used. In particular, from the viewpoints of, for example, charge characteristics and preventing foreign substances from adhering to the surface of the carrier, a (meth)acrylic resin or a silicone resin can be used. In particular, a (meth)acrylic resin having an alicyclic hydrocarbon group, such as a cyclohexyl group, a cycloheptyl group, a cyclooctyl group, a cyclopentyl group, a cyclobutyl group, or a cyclopropyl group, can be used because the surface (coating film surface) of the resin cover layer covering the surface of the magnetic material becomes smooth, and adhesion of the components derived from the toner, such as the binder resin, the release agent, and the external additive, can be reduced.

In the case where the toner is mixed with a magnetic carrier and used as a two-component developer, the toner concentration in the two-component developer is preferably 2% by mass or more and 15% by mass or less, more preferably 4% by mass or more and 13% by mass or less.

### Method for Producing Toner

The method for producing the toner according to the present disclosure is not particularly limited, and a known method such as a pulverization method, a suspension polymerization method, a dissolution suspension method, an emulsion aggregation method, or a dispersion polymerization method can be employed.

A procedure for producing a toner by the emulsion aggregation method will be described below.

The method for producing a toner may be a method including:
Step 1: a step of aggregating resin particles in an aqueous medium to form aggregated particles, and
Step 2: a step of fusing the aggregated particles formed in Step 1 to obtain fused aggregated particles.

In Step 1, the resin particles are prepared by, for example, dispersing an amorphous resin and, as needed, optional components such as a crystalline polyester resin, a colorant, a release agent, and a dispersant (hereinafter, a resin component and optional components are also collectively referred to as “resin component, etc.”) in an aqueous medium and obtained as an aqueous dispersion liquid of these components.

The aqueous medium may contain water as a main component. From the viewpoint of improving dispersion stability of the aqueous dispersion liquid and the viewpoint of the environment, the water content in the aqueous medium is preferably 80% by mass or more, more preferably 90% by mass or more, still more preferably 95% by mass or more, still further more preferably 98% by mass or more, yet still further more preferably 100% by mass. The water may be deionized water or distilled water.

Components other than water that the aqueous medium may contain are organic solvents soluble in water, such as alkyl alcohols having 1 to 5 carbon atoms; dialkyl ketones having 3 to 5 carbon atoms, such as acetone and methyl ethyl ketone; and cyclic ethers such as tetrahydrofuran. Of these, alkyl alcohols that have 1 to 5 carbon atoms and that do not dissolve polyester resins are preferred, and methanol, ethanol, isopropanol, or butanol is more preferred from the viewpoint of preventing the organic solvent from being mixed in the toner.

Examples of the method for preparing the aqueous dispersion liquid of the resin particles include a method in which the resin component, etc. are added to an aqueous medium, and dispersion treatment is performed using a disperser or the like, and a method (phase-inversion emulsification) in which an aqueous medium is gradually added to a melt or organic solvent solution of the resin component, etc. to cause phase-inversion emulsification.

Of these, the method of phase-inversion emulsification can be employed from the viewpoint of improving low-temperature fixability and endurance of the toner. The phase-inversion emulsification method may be a method in which the resin component, etc. are dissolved in an organic solvent to prepare an organic solvent solution of the resin component, etc., and an aqueous medium is added to the prepared solution to cause phase-inversion emulsification, or a method in which an aqueous medium is added to a resin mixture prepared by melting and mixing the resin component, etc. to cause phase-inversion emulsification. Examples of organic solvents used in the phase-inversion emulsification method include alcohol solvents such as ethanol, isopropanol, and isobutanol; ketone solvents such as acetone, methyl ethyl ketone, methyl isobutyl ketone, and diethyl ketone; ether solvents such as dibutyl ether, tetrahydrofuran, and dioxane; and acetic acid ester solvents such as ethyl acetate and isopropyl acetate.

In the phase-inversion emulsification method, the resin may be treated with a neutralizing agent. The neutralizing agent may be, for example, a basic substance. Examples of basic substances include alkali metal hydroxides such as lithium hydroxide, sodium hydroxide, and potassium hydroxide; and nitrogen-containing basic substances such as ammonia, trimethylamine, ethylamine, diethylamine, triethylamine, diethanolamine, triethanolamine, and tributylamine. Of these, at least one selected from ammonia and alkali metal hydroxides is preferred, at least one selected from ammonia and sodium hydroxide is more preferred, and sodium hydroxide is still more preferred in view of dispersion stability and cohesiveness.

The equivalent weight (% by mole) of the neutralizing agent used relative to acid groups of the resin is preferably 10% by mole or more, more preferably 30% by mole or more, and preferably 150% by mole or less, more preferably 120% by mole or less, still more preferably 100% by mole or less. The temperature at which the aqueous medium is added is preferably 20° C. or higher, more preferably 40° C. or higher, still more preferably 50° C. or higher and 70° C. or lower from the viewpoint of improving dispersion stability of the resin particles.

From the viewpoint of obtaining resin particles having a small particle size, the addition rate of the aqueous medium until the phase inversion is completed is preferably 0.1 parts by mass/min or more, more preferably 0.5 parts by mass/min or more, still more preferably 3 parts by mass/min or more relative to 100 parts by mass of the resin constituting the resin particles. The addition rate is preferably 50 parts by mass/min or less, more preferably 30 parts by mass/min or less, still more preferably 20 parts by mass/min or less, still further more preferably 10 parts by mass/min or less. The addition rate of the aqueous medium after the phase inversion is not limited.

After the phase-inversion emulsification, the organic solvent may be removed from the resulting dispersion as needed. The method for removing the organic solvent may be distillation because the organic solvent is dissolved with water.

The solid content of the aqueous dispersion liquid of the resin particles is preferably 5% by mass or more, more preferably 10% by mass or more, still more preferably 15% by mass or more and 25% by mass or less from the viewpoints of improving productivity of the toner and improving dispersion stability of the resin particles in the aqueous dispersion liquid. Note that the solid content is the total amount of nonvolatile components such as a resin, a colorant, a surfactant, etc.

The volume-median particle size (D50) of the resin particles in the aqueous dispersion liquid is preferably 50 nm or more and 800 nm or less, more preferably 100 nm or more and 300 nm or less. The dispersion particle size of particles dispersed in the aqueous medium is measured with a dynamic light scattering particle size distribution analyzer (Nanotrac UPA-EX150: manufactured by Nikkiso Co., Ltd.).

As for an amorphous resin, and optional components such as a crystalline polyester resin, a colorant and a release agent, dispersion liquids may be separately prepared by dispersing each component in an aqueous medium and then mixed together to obtain aggregated particles, as described above. For example, an aqueous dispersion liquid of a release agent (release agent dispersion liquid) may be obtained by dispersing release agent particles in an aqueous medium at a temperature equal to or higher than the melting point of the release agent using a disperser. The dispersion of the release agent particles in the aqueous medium may be performed in the presence of a surfactant from the viewpoints of improving dispersion stability of the release agent particles and obtaining uniform aggregated particles. Examples of surfactants include anionic surfactants such as sodium dodecylbenzenesulfonate, sodium dodecyl sulfate, sodium lauryl ether sulfate, and dipotassium alkenyl succinate; cationic surfactants; and nonionic surfactants. The content of the surfactant is preferably 0.1% by mass or more and 3.0% by mass or less from the viewpoints of improving dispersion stability of the release agent particles, and improving cohesiveness of the release agent particles during the production of the toner and preventing the release agent particles from isolating. The solid content of the release agent dispersion liquid is preferably 15% by mass or more and 25% by mass or less in view of productivity and dispersion stability of the toner.

Examples of the disperser for dispersing optional components such as a crystalline polyester, a colorant, and a release agent include a homogenizer, an ultrasonic disperser, and a high-pressure disperser. Prior to the dispersion with the disperser, the optional components, the surfactant, and the aqueous medium may be preliminarily dispersed with a mixer such as a homo mixer or a ball mill.

An aqueous dispersion liquid of a colorant may be obtained by dispersing colorant particles optionally in the presence of a surfactant using a disperser, as in the release agent dispersion liquid.

Examples of surfactants used in the preparation of the colorant dispersion liquid include nonionic surfactants, anionic surfactants, and cationic surfactants. Anionic surfactants can be used from the viewpoints of improving dispersion stability of colorant particles and improving cohesiveness of the colorant particles with other resin particles. Specific examples thereof include sodium dodecylbenzenesulfonate, sodium dodecyl sulfate, sodium lauryl ether sulfate, and dipotassium alkenyl succinate. In particular, sodium dodecylbenzenesulfonate can be used.

The content of the surfactant in the colorant dispersion liquid is preferably 1.0% by mass or more and 4.5% by mass or less from the viewpoint of dispersion stability and cohesiveness of the colorant particles and from the viewpoint of preventing the colorant particles from isolating. The solid content of the colorant dispersion liquid is preferably 15% by mass or more and 25% by mass or less in view of productivity and dispersion stability of the toner. The volume-median particle size (D50) of the colorant particles is preferably 50 nm or more and 800 nm or less, more preferably 100 nm or more and 200 nm or less. The dispersion particle size of particles dispersed in the aqueous medium is measured with a dynamic light scattering particle size distribution analyzer (Nanotrac UPA-EX150: manufactured by Nikkiso Co., Ltd.).

When aggregated particles are obtained in Step 1, an aggregating agent containing aluminum and at least one metal element selected from the group consisting of calcium, magnesium, sodium, and barium may be added.

Examples of aggregating agents containing the above metal elements include cationic surfactants of quaternary salts and inorganic aggregating agents such as inorganic metal salts, inorganic ammonium salts, and metal complexes. Of these, inorganic aggregating agents can be used from the viewpoint of improving cohesiveness and obtaining uniform aggregated particles. Examples of inorganic metal salts include metal salts such as sodium sulfate, sodium nitrate, sodium chloride, calcium chloride, and calcium nitrate; and inorganic metal salt polymers such as polyaluminum chloride and polyaluminum hydroxide.

The amount of aggregating agent added is adjusted such that the total content M (mmol/kg) of calcium, magnesium, sodium, and barium becomes 5 mmol/kg or more and 50 mmol/kg or less relative to the mass of the toner in order to suppress an excessive decrease in the viscosity and excessive thermal contraction as described above. In addition, the amount of aggregating agent added is adjusted such that the aluminum content A (mmol/kg) becomes 0.5 mmol/kg or more and 50 mmol/kg or less relative to the mass of the toner. Specifically, the amount of aggregating agent is preferably 1 part by mass or more and 50 parts by mass or less relative to 100 parts by mass of the resin solid component.

The aggregating agent may be added dropwise, as an aqueous solution, to a dispersion liquid mixture, and the concentration of the aqueous solution of the aggregating agent is preferably 2% by mass or more and 30% by mass or less. From the viewpoint of controlling aggregation to provide aggregated particles having a desired particle size and a desired particle size distribution, the aqueous solution of the aggregating agent can be adjusted to a pH of 7.0 or more and 9.0 or less and used. The time of dropwise addition of the aggregating agent is preferably 1 minute or more and 120 minutes or less from the viewpoint of controlling aggregation to provide aggregated particles having a desired particle size. The aggregation temperature during dropwise addition of the aggregating agent is preferably 15° C. or higher and 40° C. or lower.

From the viewpoint of accelerating aggregation to provide aggregated particles having a desired particle size and a desired particle size distribution, the temperature of the dispersion liquid may be increased after the addition of the aggregating agent. The holding temperature is preferably 45° C. or higher, more preferably 50° C. or higher, and preferably 80° C. or lower, more preferably 70° C. or lower, still more preferably 65° C. or lower.

Furthermore, aggregation may be stopped when the toner is grown to an appropriate particle size. Examples of the method for stopping aggregation include a method of cooling the dispersion liquid, a method of adding an aggregation terminator, and a method of diluting the dispersion liquid.

The method for stopping aggregation by adding an aggregation terminator can be employed from the viewpoint of reliably preventing unnecessary aggregation. The aggregation terminator is preferably a surfactant, more preferably an anionic surfactant. Examples of anionic surfactants include alkylbenzene sulfonates, alkyl sulfates, alkyl ether sulfates, and polyoxyalkylene alkyl ether sulfates. A polyoxyalkylene alkyl ether sulfate is preferred, a polyoxyethylene lauryl ether sulfate is more preferred, and sodium polyoxyethylene lauryl ether sulfate is still more preferred.

In Step 2, which is a step of subjecting the aggregated particles formed in Step 1 to melt-adhesion/fusion, holding may be performed at a temperature equal to or higher than the maximum value of the glass transition temperature from the viewpoint of improving melt-adhesion properties of the aggregated particles and enhancing endurance. The holding time at the temperature is preferably 1 minute or more, more preferably 10 minutes or more, still more preferably 30 minutes or more, and 240 minutes or less, more preferably 180 minutes or less, still more preferably 120 minutes or less.

The circularity of the aggregated particles obtained in Step 2 is preferably 0.955 or more, more preferably 0.960 or more, still more preferably 0.965 or more from the viewpoint of improving low-temperature fixability and the ease of cleaning the toner. The circularity of the aggregated particles is preferably 0.990 or less, more preferably 0.985 or less, still more preferably 0.980 or less. The aggregated particles obtained in Step 2 may be subjected to post-treatment steps as appropriate and isolated. For example, since the aggregated particles obtained in Step 2 are present in an aqueous medium, solid-liquid separation may be first performed.

For the solid-liquid separation, a suction filtration method or the like may be employed.

After the solid-liquid separation, washing may be performed. At this time, the added surfactant may also be removed, and thus the washing may be performed with an aqueous medium at a temperature equal to or lower than the cloud point of the surfactant. The washing may be performed a plurality of times.

After the solid-liquid separation, drying may be performed. The temperature during drying may be set so as to be lower than the minimum value of the glass transition temperature of the aggregated particles. The drying method may be vacuum low-temperature drying, vibration flow drying, spray drying, freeze drying, flash jet drying, or the like.

After the drying, an external addition step of mixing toner particles and an external additive may be performed.

Methods for measuring various physical properties will be described below.

Method for Separating Each Material from Toner

Each material can be separated from a toner by utilizing the difference in solubility in a solvent between materials included in the toner or GPC. First separation: The toner is dissolved in methyl ethyl ketone (MEK) at 23° C. to separate soluble matter (amorphous resin) and insoluble matter (such as crystalline polyester, release agent, colorant, and inorganic fine particles) from each other. Second separation: The insoluble matter (such as crystalline polyester, release agent, colorant, and inorganic fine particles) obtained in the first separation is dissolved in MEK at 100° C. to separate soluble matter (crystalline polyester and release agent) and insoluble matter (such as colorant and inorganic fine particles) from each other. Third separation: The soluble matter (crystalline polyester and release agent) obtained in the second separation is dissolved in chloroform at 23° C. to separate soluble matter (crystalline polyester) and insoluble matter (release agent) from each other. Fourth separation: In the case of further separating the amorphous resin, the soluble matter obtained in the first separation is separated by utilizing the molecular weight or the difference in polarity by GPC.

Method for confirming attribution of various monomer units in amorphous resin and crystalline polyester and method for measuring contents of the monomer units

The confirmation of the attribution of various monomer units in an amorphous resin and a crystalline polyester and the measurement of the contents of the monomer units are performed by 1H-NMR under the following conditions.

Measuring apparatus: FT NMR apparatus JNM-EX400 (manufactured by JEOL Ltd.)
Measurement frequency: 400 MHZ
Pulse condition: 5.0 μs
Frequency range: 10,500 Hz
Number of scans: 64
Measurement temperature: 30° C.
Specimen: A specimen is prepared by placing 50 mg of a measurement specimen in a sample tube with an inner diameter of 5 mm, adding deuterated chloroform (CDCl₃) as a solvent, and dissolving this measurement specimen in a thermostatic chamber at 40° C.

The structures of various monomer units are specified from the obtained 1H-NMR chart, and integral values S₁, S₂, S₃, . . . , and Sn of peaks attributed to the monomer units are calculated.

The monomer unit content of each polymerizable monomer is determined using the integral values S₁, S₂, S₃, . . . , and Sn as follows. Note that n₁, n₂, n₃, . . . , and nₙ are each the number of hydrogen atoms in the respective monomer units.

$$Content of each monomer unit ( \% by mole ) = \{ ( {S}_{n} / {n}_{n} ) / ( ( {S}_{1} / {n}_{1} ) + ( {S}_{2} / {n}_{2} ) + ( {S}_{3} / {n}_{3} ) ⋯ + ( {S}_{n} / {n}_{n} ) ) \} \times 100$$

The numerator term of a similar operation is changed, and the content (% by mole) of each monomer unit is calculated. When a polymerizable monomer containing no hydrogen atoms is used as a monomer unit, ¹³C-NMR measurement, in which the nucleus to be measured is ¹³C, is performed in a single pulse mode, and the calculation is performed in the same manner by ¹H-NMR.

Method for measuring element content in toner by X-ray fluorescence

A wavelength-dispersive X-ray fluorescence analyzer “Axios” (manufactured by PANalytical) and attached dedicated software “SuperQ ver. 4.0F” (manufactured by PANalytical) for setting the measurement conditions and analyzing the measurement data are used. Rhodium (Rh) is used as an anode of an X-ray tube, the measurement atmosphere is vacuum, the measurement diameter (collimator mask diameter) is 27 mm, and the measurement time is 10 seconds. For the measurement of light elements, a proportional counter (PC) is used for detection. For the measurement of heavy elements, a scintillation counter (SC) is used for detection. As a measurement sample, 4 g of a toner is put into a special aluminum ring for pressing, flattened, and then pressurized at 20 MPa for 60 seconds using a tablet molding machine “BRE-32” (manufactured by Maekawa Testing Machine Mfg. Co., Ltd.) to form a pellet with a thickness of 2 mm and a diameter of 39 mm. For quantification, an element to be quantified is added such that the content becomes 5.0 ppm on a mass basis relative to 100 parts by mass of a resin sample that does not contain the element, and the resulting mixture is sufficiently mixed using a coffee mill. Similarly, the element to be quantified is mixed with the resin sample such that the content becomes 50.0 ppm, 500.0 ppm, and 5,000.0 ppm, and these mixtures are used as specimens for a calibration curve. Each of the specimens is formed into a pellet for the preparation of the calibration curve using the tablet molding machine in the same manner as described above and used for measurement. In this measurement, the accelerating voltage and the current value of the X-ray generator are 24 kV and 100 mA, respectively. A linear calibration curve is obtained by plotting the X-ray counting rate on the vertical axis and the amount of element added in each specimen for the calibration curve on the horizontal axis. Next, the toner to be analyzed is formed into a pellet as described above using the tablet molding machine and subjected to the measurement. Subsequently, the element content in the toner is determined from the calibration curve (calculation of Net intensity). The X-ray intensity obtained in the measurement and determined by subtracting the background intensity from the X-ray intensity at a peak angle that indicates the presence of the element is defined as a Net intensity. Method for calculating SP values of amorphous resin and crystalline polyester

The SP values of an amorphous resin and a crystalline polyester are calculated in accordance with the calculation method proposed by Fedors.

Specifically, energy of evaporation (Aei), a molar volume (Avi), and a molar ratio (j) in the resin are determined for each monomer unit. The SP value is calculated using these values from the following formula.

$$SP value {( cal / {cm}^{3} )}^{0.5} = {\{ ( \sum j \times \sum Δ ei ) / ( \sum j \times \sum Δ vi ) \}}^{0.5}$$

For the energy of evaporation (Aei) and the molar volume (Avi) of an atom or an atomic group in the monomer unit, values described in “polym. Eng. Sci., 14 (2), 147-154 (1974)” are used.

Method for measuring glass transition temperature Tg of amorphous resin

The glass transition temperature Tg of an amorphous resin is measured using a differential scanning calorimeter “Q2000” (manufactured by TA Instruments) in accordance with ASTM D3418-82. The melting points of indium and zinc are used for the temperature correction of a detecting unit of the apparatus, and the heat of fusion of indium is used for the correction of heat quantity. Specifically, about 3 mg of an amorphous resin is precisely weighed, placed in an aluminum pan, and measured under the following conditions while an empty aluminum pan is used as a reference.

Temperature rise rate: 10° C./min
Measurement start temperature: 30° C.
Measurement end temperature: 180° C.

The measurement is performed in a measurement range of 30° C. to 180° C. at a temperature rise rate of 10° C./min. The temperature is increased to 180° C. once and held for 10 minutes, then decreased to 30° C., and then increased again. In this second temperature rise process, a change in specific heat is observed in a temperature range of 30° C. to 100° C. In this case, the intersection point of a line at the midpoint of the baselines before and after the change in specific heat appears and the differential thermal curve is defined as the glass transition temperature Tg of the amorphous resin. Method for measuring weight-average molecular weight of amorphous resin by GPC

The molecular weight (Mw) of THF-soluble matter of an amorphous resin is measured by gel permeation chromatography (GPC) as follows.

First, a toner is dissolved in tetrahydrofuran (THF) at room temperature over a period of 24 hours. The obtained solution is then filtered through a solvent-resistant membrane filter “Maishori Disc” (manufactured by Tosoh Corporation) having a pore diameter of 0.2 μm to obtain a sample solution. The sample solution is adjusted such that the concentration of the component soluble in THF is about 0.8% by mass. Measurement is performed using this sample solution under the following conditions. Apparatus: HLC8120 GPC (detector: RI) (manufactured by Tosoh Corporation) Columns: connected seven columns, Shodex KF-801, 802, 803, 804, 805, 806, and 807 (manufactured by Resonac Holdings Corporation)

Eluent: tetrahydrofuran (THF)
Flow rate: 1.0 mL/min
Oven temperature: 40.0° C.
Amount of sample injected: 0.10 mL

The molecular weight of a sample is calculated by using a molecular weight calibration curve prepared by using standard polystyrene resins (for example, trade name “TSK standard polystyrene F-850, F-450, F-288, F-128, F-80, F-40, F-20, F-10, F-4, F-2, F-1, A-5000, A-2500, A-1000, and A-500” manufactured by Tosoh Corporation).

Method for measuring weight-average molecular weight of crystalline polyester by GPC

The molecular weight (Mw) of toluene-soluble matter of a crystalline polyester, the toluene-soluble matter being soluble in toluene at 100° C., is measured by gel permeation chromatography (GPC) as follows.

First, the crystalline polyester is dissolved in toluene at 100° C. over a period of one hour. The obtained solution is filtered through a solvent-resistant membrane filter “Maishori Disc” (manufactured by Tosoh Corporation) having a pore diameter of 0.2 μm to obtain a sample solution. The sample solution is adjusted such that the concentration of the component soluble in toluene is about 0.1% by mass. Measurement is performed using this sample solution under the following conditions.

Apparatus: HLC-8121 GPC/HT (manufactured by Tosoh Corporation)
Columns: connected two columns, TSKgel GMHHR-H HT (7.8 cm I.D×30 cm)
(manufactured by Tosoh Corporation)
Detector: RI for high temperature

### Temperature: 135° C.

Solvent: toluene
Flow rate: 1.0 mL/min
Sample: 0.4 mL of a 0.1% sample is injected

The molecular weight of a sample is calculated by using a molecular weight calibration curve prepared by using monodisperse polystyrene standard samples. Furthermore, the molecular weight is calculated by performing polyethylene conversion using the conversion formula derived from the Mark-Houwink viscosity equation. Method for measuring melt peak temperature (melting point) Tc (° C.) of crystalline polyester or the like

The melting point (Tc) of a crystalline polyester is measured using a differential scanning calorimeter “Q2000” (manufactured by TA Instruments) in accordance with ASTM D3418-82.

The melting points of indium and zinc are used for the temperature correction of a detecting unit of the apparatus, and the heat of fusion of indium is used for the correction of heat quantity. Specifically, 3 mg of a sample is precisely weighed, placed in an aluminum pan, and measured under the following conditions while an empty aluminum pan is used as a reference.

Temperature rise rate: 10° C./min
Measurement start temperature: 30° C.
Measurement end temperature: 180° C.

The measurement is performed in a measurement range of 30° C. to 180° C. at a temperature rise rate of 10° C./min. The temperature is increased to 180° C. once and held for 10 minutes, then decreased to 30° C., and then increased again. In this second temperature rise process, the temperature of the maximum endothermic peak in a temperature-amount of heat absorption curve in a range of 30° C. to 100° C. is defined as the melting point.

### EXAMPLES

The present disclosure will be described in more detail with reference to Examples and Comparative Examples. However, the present disclosure is not limited thereto. In the following formulations, “part” is based on mass unless otherwise specified.

Production of amorphous resin A1
Polyethylene terephthalate (molecular weight: 2,000, intrinsic viscosity: 0.1): 20.9 parts (42.0% by mole)
Propylene oxide adduct of bisphenol A (average number of moles added: 2.0 moles): 47.4 parts (29.0% by mole)
Terephthalic acid: 15.8 parts (18.3% by mole)
Dodecenylsuccinic acid: 15.8 parts (10.6% by mole)
Titanium tetrabutoxide (esterification catalyst): 0.5 parts
Gallic acid (esterification promoter): 0.1 parts

The above materials were weighed into a reaction vessel equipped with a reflux condenser, a stirrer, a nitrogen introduction tube, and a thermocouple.

Next, the inside of the reaction vessel was purged with a nitrogen gas, the temperature was then gradually raised with stirring, and a reaction was performed for two hours at a temperature of 200° C. with stirring. Note that the molar proportion of polyethylene terephthalate is a value of a total number of units of the number of units derived from ethylene glycol and the number of units derived from terephthalic acid.

Furthermore, the pressure in the reaction vessel was decreased to 8.3 kPa, and the reaction was performed for five hours while the temperature of 200° C. was maintained. After it was confirmed that the weight-average molecular weight reached 6,700, the temperature was decreased to stop the reaction. Thus, an amorphous resin A1 having a polyethylene terephthalate structural moiety in its molecule was obtained. Physical properties of the amorphous resin A1 determined by the measurement methods described above are shown in Table 1-1.

Production of amorphous resins A2 to A10 and amorphous resins A12 to A17

Amorphous resins A2 to A10 and amorphous resins A12 to A17 having a polyethylene terephthalate structural moiety in their molecules were obtained in the same manner as the production of the amorphous resin A1 except that the types and the numbers of parts of polyethylene terephthalate and polymerizable monomers were changed as shown in Tables 1-1 to 1-3. Physical properties of the amorphous resins A2 to A10 and the amorphous resins A12 to A17 determined by the measurement methods described above are shown in Tables 1-1 to 1-3.

Production of amorphous resin A11
Polyethylene terephthalate (molecular weight: 2,000, intrinsic viscosity: 0.1): 22.6 parts (41.1% by mole)
Propylene oxide adduct of bisphenol A (average number of moles added: 2.0 moles): 55.0 parts (29.5% by mole)
Terephthalic acid: 5.5 parts (5.6% by mole)
Suberic acid: 16.0 parts (23.8% by mole)
Titanium tetrabutoxide (esterification catalyst): 0.5 parts
Gallic acid (esterification promoter): 0.1 parts

The above materials were weighed into a reaction vessel equipped with a reflux condenser, a stirrer, a nitrogen introduction tube, and a thermocouple.

Next, the inside of the reaction vessel was purged with a nitrogen gas, the temperature was then gradually raised with stirring, and a reaction was performed for two hours at a temperature of 200° C. with stirring.

Furthermore, the pressure in the reaction vessel was decreased to 8.3 kPa, and the reaction was performed for five hours while the temperature of 200° C. was maintained. After it was confirmed that the weight-average molecular weight reached 6,700, the temperature was decreased to stop the reaction. Thus, an amorphous resin A11 was obtained. Physical properties of the amorphous resin A11 determined by the measurement methods described above were as follows: SP value, 11.30 (cal/cm³) 0.5; WEG, 20.8% by mole; WCH, 23.8% by mole; Tg, 48.5° C.

TABLE 1-1

| | | Amorphous | | Amorphous | | Amorphous | | Amorphous | | Amorphous | | Amorphous | |
|---|---|---|---|---|---|---|---|---|---|---|---|---|---|
| | | resin A1 | | resin A2 | | resin A3 | | resin A4 | | resin A5 | | resin A6 | |
| | | parts | mol % | parts | mol % | parts | mol % | parts | mol % | parts | mol % | parts | mol % |
| Polyethylene terephthalate | | 20.9 | 42.0 | 19.7 | 40.3 | 19.4 | 39.9 | 22.7 | 44.4 | 23.0 | 44.8 | 12.3 | 27.2 |
| Alcohol | BPA-PO | 47.4 | 29.0 | 44.6 | 27.9 | 44.0 | 27.6 | 51.5 | 30.7 | 52.2 | 30.9 | 52.6 | 36.4 |
| component | BPA-EO | | | | | | | | | | | | |
| | Ethylene glycol | | | | | | | | | | | | |
| Carboxylic | Terephthalic acid | 15.8 | 18.3 | 14.9 | 17.6 | 14.7 | 17.4 | 17.2 | 19.3 | 17.4 | 19.5 | 17.5 | 23.0 |
| acid | Dodecenylsuccinic | 15.8 | 10.6 | 20.8 | 14.3 | 22.0 | 15.2 | 8.6 | 5.6 | 7.4 | 4.8 | 17.5 | 13.4 |
| component | acid | | | | | | | | | | | | |
| | Tetradecanedioic | | | | | | | | | | | | |
| | acid | | | | | | | | | | | | |
| | Suberic acid | | | | | | | | | | | | |
| | Octadecanedioic | | | | | | | | | | | | |
| | acid | | | | | | | | | | | | |
| | Adipic acid | | | | | | | | | | | | |
| | Eicosanedioic acid | | | | | | | | | | | | |
| | Trimellitic acid | | | | | | | | | | | | |

| | | | | | | | |
|---|---|---|---|---|---|---|---|
| Physical | SP | 11.30 | 11.26 | 11.25 | 11.37 | 11.38 | 11.13 |
| properties | W_{EG} | 21.4 | 20.6 | 20.3 | 22.6 | 22.8 | 13.4 |
| | W_{CH} | 10.6 | 14.3 | 15.2 | 5.6 | 4.8 | 13.4 |
| | Tg | 45.3 | 40.5 | 39.8 | 54.8 | 55.5 | 42.3 |
| | Mw | 6700 | 6700 | 6700 | 6700 | 6700 | 6700 |

TABLE 1-2

| | | Amorphous | | Amorphous | | Amorphous | | Amorphous | | Amorphous | |
|---|---|---|---|---|---|---|---|---|---|---|---|
| | | resin A7 | | resin A8 | | resin A9 | | resin A10 | | resin A12 | |
| | | parts | mol % | parts | mol % | parts | mol % | parts | mol % | parts | mol % |
| Polyethylene terephthalate | | 11.0 | 24.9 | 25.4 | 47.9 | 27.0 | 49.9 | 22.7 | 43.1 | 23.0 | 44.7 |
| Alcohol | BPA-PO | 53.4 | 37.6 | 44.8 | 26.1 | 43.8 | 25.1 | 50.6 | 29.8 | 52.2 | 30.9 |
| component | BPA-EO | | | | | | | | | | |
| | Ethylene glycol | | | | | | | | | | |
| Carboxylic | Terephthalic acid | 17.8 | 23.7 | 14.9 | 16.4 | 14.6 | 15.8 | 16.9 | 18.8 | 17.4 | 19.5 |
| acid | Dodecenylsuccinic acid | 17.8 | 13.8 | 14.9 | 9.6 | 14.6 | 9.2 | | | | |
| component | Tetradecanedioic acid | | | | | | | 10.1 | 8.3 | | |
| | Suberic acid | | | | | | | | | | |
| | Octadecanedioic acid | | | | | | | | | 7.4 | 4.9 |
| | Adipic acid | | | | | | | | | | |
| | Eicosanedioic acid | | | | | | | | | | |
| | Trimellitic acid | | | | | | | | | | |

| | | | | | | |
|---|---|---|---|---|---|---|
| Physical | SP | 11.10 | 11.40 | 11.44 | 11.30 | 11.30 |
| properties | W_{EG} | 12.5 | 24.1 | 25.0 | 22.0 | 22.8 |
| | W_{CH} | 13.8 | 9.6 | 9.2 | 8.3 | 4.9 |
| | Tg | 41.8 | 48.2 | 49.1 | 46.1 | 45.9 |
| | Mw | 6700 | 6700 | 6700 | 6700 | 6700 |

TABLE 1-3

| | | Amorphous | | Amorphous | | Amorphous | | Amorphous | | Amorphous | |
|---|---|---|---|---|---|---|---|---|---|---|---|
| | | resin A13 | | resin A14 | | resin A15 | | resin A16 | | resin A17 | |
| | | parts | mol % | parts | mol % | parts | mol % | parts | mol % | parts | mol % |
| Polyethylene terephthalate | | 10.0 | 22.9 | 28.5 | 51.7 | 22.6 | 41.1 | 23.0 | 45.1 | 28.7 | 55.7 |
| Alcohol | BPA-PO | 54.0 | 38.6 | 42.9 | 24.2 | 55.0 | 29.5 | 52.4 | 31.1 | 36.6 | 21.7 |
| component | BPA-EO | | | | | | | | | 14.6 | 9.5 |
| | Ethylene glycol | | | | | | | | | | |
| Carboxylic | Terephthalic acid | 18.0 | 24.3 | 14.3 | 15.2 | 5.5 | 5.6 | 17.5 | 19.6 | 2.2 | 2.5 |
| acid | Dodecenylsuccinic acid | 18.0 | 14.1 | 14.3 | 8.9 | | | | | 9.3 | 6.1 |
| component | Tetradecanedioic acid | | | | | | | | | | |
| | Suberic acid | | | | | | | | | | |
| | Octadecanedioic acid | | | | | | | | | | |
| | Adipic acid | | | | | 16.0 | 23.8 | | | | |
| | Eicosanedioic acid | | | | | | | 7.0 | 4.2 | | |
| | Trimellitic acid | | | | | | | | | 8.6 | 4.5 |

| | | | | | | |
|---|---|---|---|---|---|---|
| Physical | SP | 11.08 | 11.47 | 11.30 | 11.30 | 11.45 |
| properties | W_{EG} | 11.4 | 25.9 | 20.8 | 23.0 | 28.3 |
| | W_{CH} | 14.1 | 8.9 | 23.8 | 4.2 | 6.1 |
| | Tg | 41.1 | 49.7 | 49.1 | 45.6 | 53.0 |
| | Mw | 6700 | 6700 | 6700 | 6700 | 6700 |

The abbreviations in Tables 1-1 to 1-3 are as follows. BPA-PO:

Propylene oxide adduct of bisphenol A (average number of moles added: 2.0 moles) BPA-EO:

Ethylene oxide adduct of bisphenol A (average number of moles added: 2.0 moles) Production of amorphous resin B
Polyethylene terephthalate (molecular weight: 2,000, intrinsic viscosity: 0.1): 4.1 parts (9.8% by mole)
Propylene oxide adduct of bisphenol A (average number of moles added: 2.0 moles): 57.8 parts (42.8% by mole)
Terephthalic acid: 29.9 parts (41.9% by mole)
Trimellitic acid: 7.0 parts (4.5% by mole)
Stearic acid: 1.2 parts (1.0% by mole)
Titanium tetrabutoxide (esterification catalyst): 0.5 parts
Gallic acid (esterification promoter): 0.1 parts

The above materials were weighed into a reaction vessel equipped with a reflux condenser, a stirrer, a nitrogen introduction tube, and a thermocouple.

Next, the inside of the reaction vessel was purged with a nitrogen gas, the temperature was then gradually raised with stirring, and a reaction was performed for two hours at a temperature of 200° C. with stirring.

Furthermore, the pressure in the reaction vessel was decreased to 8.3 kPa, and the reaction was performed for five hours while the temperature of 200° C. was maintained. After it was confirmed that the weight-average molecular weight reached 1,000, the temperature was decreased to stop the reaction. Thus, an amorphous resin B1 was obtained. Physical properties of the amorphous resin B1 determined by the measurement methods described above are shown in Table 2.

TABLE 2

| | | Amorphous resin B1 | |
|---|---|---|---|
| | | parts | mol % |
| Polyethylene terephthalate | | 4.1 | 9.8 |
| Alcohol component | BPA-PO | 57.8 | 42.8 |
| Carboxylic acid component | Terephthalic acid | 29.9 | 41.9 |
| | Stearic acid | 1.2 | 1.0 |
| | Trimellitic acid | 7.0 | 4.5 |
| Physical properties | SP | 11.54 | |
| | W_{EG} | 4.9 | |
| | W_{CH} | 1.0 | |
| | Tg | 74.7 | |
| | Mw | 1000 | |

The abbreviation in Table 2 is as follows. BPA-PO:

Propylene oxide adduct of bisphenol A (average number of moles added: 2.0 moles)
Production of crystalline polyester C1
Ethylene glycol: 10.2 parts (48.2% by mole)
Tetradecanedioic acid: 81.3 parts (48.3% by mole)
Behenic acid: 8.5 parts (3.5% by mole)
Titanium tetrabutoxide (esterification catalyst): 0.5 parts

The above materials were weighed into a reaction vessel equipped with a reflux condenser, a stirrer, a nitrogen introduction tube, and a thermocouple.

Next, the inside of the reaction vessel was purged with a nitrogen gas, the temperature was then gradually raised with stirring, and a reaction was performed for two hours at a temperature of 200° C. with stirring.

Furthermore, the pressure in the reaction vessel was decreased to 8.3 kPa, and the reaction was performed for five hours while the temperature of 200° C. was maintained. The temperature was then decreased to stop the reaction. Thus, a crystalline polyester C1 was obtained. Physical properties of the crystalline polyester C1 determined by the measurement methods described above are shown in Table 3.

### Production of Crystalline Polyesters C2 to C5

Crystalline polyesters C2 to C5 were obtained by conducting the reaction in the same manner except that, in the crystalline polyester C1, the types and the numbers of parts of polymerizable monomers and an aliphatic monocarboxylic acid or an aliphatic monoalcohol were changed as shown in Table 3. Physical properties of the crystalline polyesters C2 to C5 determined by the measurement methods described above are shown in Table 3.

TABLE 3

| | | Crystalline | | Crystalline | | Crystalline | | Crystalline | | Crystalline | |
|---|---|---|---|---|---|---|---|---|---|---|---|
| | | polyester | | polyester | | polyester | | polyester | | polyester | |
| | | C1 | | C2 | | C3 | | C4 | | C5 | |
| | | parts | mol % | parts | mol % | parts | mol % | parts | mol % | parts | mol % |
| Alcohol | Ethylene glycol | 10.2 | 48.2 | 10.2 | 47.6 | 10.2 | 47.5 | 10.1 | 48.5 | 10.1 | 48.7 |
| component | (number of carbon | | | | | | | | | | |
| | atoms: 2) | | | | | | | | | | |
| Carboxylic | Tetradecanedioic | 81.3 | 48.3 | 81.3 | 47.7 | 81.3 | 47.5 | 81.1 | 48.6 | 81.1 | 48.7 |
| acid | acid | | | | | | | | | | |
| component | | | | | | | | | | | |
| Aliphatic | Behenic acid | 8.5 | 3.5 | | | | | | | | |
| monocarboxylic | (number of carbon | | | | | | | | | | |
| acid | atoms: 22) | | | | | | | | | | |
| | Palmitic acid | | | 8.5 | 4.7 | | | | | | |
| | (number of carbon | | | | | | | | | | |
| | atoms: 16) | | | | | | | | | | |
| | Pentadecanoic | | | | | 8.5 | 5.0 | | | | |
| | acid (number of | | | | | | | | | | |
| | carbon atoms: 15) | | | | | | | | | | |
| | Montanic acid | | | | | | | 8.8 | 2.9 | | |
| | (number of carbon | | | | | | | | | | |
| | atoms: 28) | | | | | | | | | | |
| | Lacceric acid | | | | | | | | | 8.8 | 2.6 |
| | (number of carbon | | | | | | | | | | |
| | atoms: 32) | | | | | | | | | | |

| | | | | | | |
|---|---|---|---|---|---|---|
| Physical | SP | 10.09 | 10.11 | 10.12 | 10.09 | 10.08 |
| properties | Tc | 92.0 | 90.0 | 89.0 | 94.0 | 95.0 |
| | Mw | 18000 | 18000 | 18000 | 18000 | 18000 |

Preparation of particle dispersion liquids of amorphous resins A1 to A17 and B1

Into a container equipped with a temperature control unit and a nitrogen purging unit, 40 parts of ethyl acetate and 25 parts of 2-butanol were charged to prepare a mixed solvent. Subsequently, 100 parts of the amorphous resin A1 was gradually added and dissolved in the mixed solvent. To the resulting solution, a 10% aqueous ammonia solution was added (in an amount three times by mole with respect to the acid value of the resin), and stirring was performed for 30 minutes.

Subsequently, the inside of the container was purged with dry nitrogen. While the temperature was maintained at 40° C. and the liquid mixture was stirred, 400 parts of deionized water was added dropwise to the liquid mixture at a rate of 2 parts/min to perform emulsification. After completion of the dropwise addition, the temperature of the resulting emulsion was returned to 25° C. Thus, a resin particle dispersion liquid in which resin particles having a volume-average particle diameter of 150 nm were dispersed was prepared. Deionized water was added to the resin particle dispersion liquid to adjust the solid content to 20%. Thus, an amorphous resin particle dispersion liquid A1 was prepared.

Similarly, amorphous resin particle dispersion liquids A2 to A17 and B1 were prepared using the amorphous resins A2 to A17 and B1, respectively.

Preparation of particle dispersion liquid of crystalline polyester C1
Crystalline polyester C1:90 parts
Anionic surfactant Neogen RK (DKS Co., Ltd.): 1.8 parts
Deionized water: 210 parts

The above materials were mixed and heated to 120° C., and the resulting mixture was sufficiently dispersed using ULTRA-TURRAX T50 manufactured by IKA. Subsequently, dispersion treatment was performed using a pressure-discharge Gaulin homogenizer for one hour. Thus, a crystalline polyester particle dispersion liquid C1 containing particles with a volume-average particle diameter of 150 nm and having a solid content of 20% by mass was prepared. Similarly, crystalline polyester particle dispersion liquids C2 to C5 were prepared using the crystalline polyesters C2 to C5, respectively.

Preparation of release agent particle dispersion liquid
Release agent (trade name: FNP0090, melting point: 89.7° C., manufactured by Nippon Seiro Co., Ltd.): 270 parts
Anionic surfactant (Neogen RK, active component content: 60% by mass, manufactured by DKS Co., Ltd.)
13.5 parts (on an active component basis, 3.0% by mass relative to the release agent)
Deionized water: 721.6 parts

The above materials were mixed, and the release agent was dissolved using a pressure-discharge homogenizer (Gaulin homogenizer manufactured by Gaulin Corporation) at an internal solution temperature of 120° C. Subsequently, the resulting mixture was subjected to dispersion treatment at a dispersion pressure of 5 MPa for 120 minutes and then at a dispersion pressure of 40 MPa for 360 minutes, and cooled to prepare a release agent dispersion liquid. Deionized water was then added to the release agent dispersion liquid to adjust the solid content to 20.0% by mass. Thus, a release agent particle dispersion liquid was prepared.

Preparation of colorant dispersion liquid
Cyan pigment (ECB301, manufactured by Dainichiseika Color & Chemicals Mfg. Co., Ltd.): 200 parts
Anionic surfactant (Neogen SC, manufactured by DKS Co., Ltd.): 33 parts (active component content: 60% by mass, 10% by mass relative to the cyan pigment)· Deionized water: 750 parts

Into a stainless steel container having a volume such that, when all the above materials were charged, the liquid level reached about ⅓ of the height of the container, 280 parts of deionized water and 33 parts of the anionic surfactant were charged, and the surfactant was sufficiently dissolved. Subsequently, 200 parts of the cyan pigment was charged, and the resulting mixture was stirred with a stirrer until no dry pigment particles remained, while degassing was sufficiently performed. After degassing, the remaining part of the deionized water was added to the container, dispersion was performed with a homogenizer (ULTRA-TURRAX T50, manufactured by IKA) at 5,000 rotations for 10 minutes, and stirring was then performed with a stirrer for a whole day and night to perform degassing. After degassing, dispersion was again performed with a homogenizer at 6,000 rotations for 10 minutes, and stirring was then performed with a stirrer for a whole day and night to perform degassing. Subsequently, the dispersion liquid was dispersed at a pressure of 240 MPa with a high-pressure impact disperser Ultimizer (HJP30006, manufactured by Sugino Machine Limited). The dispersion was performed in 10 equivalent passes on the basis of the total amount of materials charged and the treatment capacity of the apparatus. The resulting dispersion liquid was left to stand for 72 hours to remove the precipitates, and deionized water was added to the dispersion liquid to adjust the solid content to 20% by mass. Production example of toner 1
Amorphous resin particle dispersion liquid A1:660 parts
Amorphous resin particle dispersion liquid B1:340 parts
Crystalline polyester particle dispersion liquid C1:130 parts
Colorant dispersion liquid: 10 parts
Release agent particle dispersion liquid: 70 parts
Sodium dodecylbenzenesulfonate: 10 parts

The amorphous resin particle dispersion liquids A1 and B1, the crystalline polyester particle dispersion liquid C1, the release agent particle dispersion liquid, and sodium dodecylbenzenesulfonate were charged into a reactor (a flask with a volume of 1 liter, an anchor blade with a baffle) and homogeneously mixed. On the other hand, the colorant dispersion liquid was homogeneously mixed in a 1,000 mL beaker and gradually added to the reactor with stirring to prepare a dispersion liquid mixture. While the dispersion liquid mixture was stirred, 12.0 parts by mass of an aqueous magnesium chloride solution serving as an aggregating agent 1 in terms of solid content, and 4.0 parts by mass of an aqueous aluminum sulfate solution serving as an aggregating agent 2 in terms of solid content were added dropwise thereto to form aggregated particles.

After completion of the dropwise addition, the system was purged with nitrogen and maintained at 50° C. for one hour and then at 55° C. for one hour. The temperature was then raised and maintained at 90° C. for 30 minutes. Subsequently, the temperature was decreased to 63° C. and then maintained for three hours to form fused particles. This reaction was performed in a nitrogen atmosphere. After a predetermined time, cooling was performed to room temperature at a temperature decrease rate of 0.5° C./min.

After cooling, the reaction product was subjected to solid-liquid separation at a pressure of 0.4 MPa through a pressure filter with a volume of 10 L to obtain a toner cake. Deionized water was then added to the pressure filter until the pressure filter was full, and washing was performed at a pressure of 0.4 MPa. Washing was further performed in the same manner for a total of three times. The toner cake was dispersed in 1 L of a methanol/water (50:50) mixed solvent in which 0.15 parts by mass of a nonionic surfactant was dissolved to prepare a surface-treated toner particle dispersion.

The toner particle dispersion was poured into a pressure filter, and 5 L of deionized water was further added thereto. Subsequently, solid-liquid separation was performed at a pressure of 0.4 MPa, and fluidized bed drying was then performed at 45° C. to obtain toner particles 1 having a number-average particle diameter of 6.0 μm. External addition step
Toner particles 1:100 parts
Fine silica particles A: fumed silica subjected to surface treatment with hexamethyldisilazane (median diameter (D50) (on a number basis): 120 nm): 4 parts
Small-particle-diameter inorganic fine particles: fine titanium oxide particles subjected to surface treatment with isobutyltrimethoxysilane (median diameter (D50) (on a number basis): 10 nm): 1 part

The toner particles 1 obtained as described above and the above materials were mixed using a Henschel Mixer (model FM-75, manufactured by Mitsui Miike Kakoki K.K.) at a rotation speed of 1,900 rpm for a rotation time of 10 minutes to obtain a toner 1 with negative chargeability. Physical properties of the toner 1 determined by the measurement methods described above are shown in Table 4-2.

### Production Examples of Toner Particles 2 to 31

Toner particles 2 to 31 were obtained in the same manner as in the production example of the toner particles 1 except that the types and addition ratios of the amorphous resin particle dispersion liquid A, the crystalline polyester particle dispersion liquid C, and the aggregating agents were changed as shown in Table 4-1.

### Production of Toner 2 to Toner 31

The toner particles 2 to 31 were subjected to the same external addition step as in the toner particles 1 to obtain toners 2 to 31, respectively.

Physical properties of the toners 2 to 31 determined by the measurement methods described above are shown in Table 4-2.

TABLE 4-1

| | | Formulation | | | | | | |
|---|---|---|---|---|---|---|---|---|
| | Toner | Amorphous | Amorphous | Crystalline | Aggregating | | Aggregating | |
| Toner | particles | resin A | resin B | polyester C | agent 1 | | agent 2 | |
| Type | Type | Type | Type | Type | Type | parts | Type | parts |
| 1 | 1 | A1 | B1 | C1 | Mg chloride | 12.0 | Al sulfate | 4.0 |
| 2 | 2 | A1 | B1 | C2 | Mg chloride | 12.0 | Al sulfate | 4.0 |
| 3 | 3 | A1 | B1 | C3 | Mg chloride | 12.0 | Al sulfate | 4.0 |
| 4 | 4 | A1 | B1 | C4 | Mg chloride | 12.0 | Al sulfate | 4.0 |
| 5 | 5 | A1 | B1 | C5 | Mg chloride | 12.0 | Al sulfate | 4.0 |
| 6 | 6 | A2 | B1 | C1 | Mg chloride | 12.0 | Al sulfate | 4.0 |
| 7 | 7 | A3 | B1 | C1 | Mg chloride | 12.0 | Al sulfate | 4.0 |
| 8 | 8 | A4 | B1 | C1 | Mg chloride | 12.0 | Al sulfate | 4.0 |
| 9 | 9 | A5 | B1 | C1 | Mg chloride | 12.0 | Al sulfate | 4.0 |
| 10 | 10 | A6 | B1 | C1 | Mg chloride | 12.0 | Al sulfate | 4.0 |
| 11 | 11 | A7 | B1 | C1 | Mg chloride | 12.0 | Al sulfate | 4.0 |
| 12 | 12 | A8 | B1 | C1 | Mg chloride | 12.0 | Al sulfate | 4.0 |
| 13 | 13 | A9 | B1 | C1 | Mg chloride | 12.0 | Al sulfate | 4.0 |
| 14 | 14 | A1 | B1 | C1 | Mg chloride | 60.0 | Al sulfate | 60.0 |
| 15 | 15 | A1 | B1 | C1 | Mg chloride | 6.0 | Al sulfate | 75.0 |
| 16 | 16 | A1 | B1 | C1 | Mg chloride | 7.0 | Al sulfate | 0.8 |
| 17 | 17 | A1 | B1 | C1 | Mg chloride | 75.0 | Al sulfate | 0.5 |
| 18 | 18 | A1 | B1 | C1 | Mg chloride | 12.0 | PAC | 4.0 |
| 19 | 19 | A1 | B1 | C1 | Ca nitrate | 12.0 | Al sulfate | 4.0 |
| 20 | 20 | A1 | B1 | C1 | Ba chloride | 12.0 | Al sulfate | 4.0 |
| 21 | 21 | A1 | B1 | C1 | Na sulfate | 12.0 | Al sulfate | 4.0 |
| 22 | 22 | A10 | B1 | C1 | Mg chloride | 12.0 | Al sulfate | 4.0 |
| 23 | 23 | A11 | B1 | C1 | Mg chloride | 12.0 | Al sulfate | 4.0 |
| 24 | 24 | A12 | B1 | C1 | Mg chloride | 12.0 | Al sulfate | 4.0 |
| 25 | 25 | A13 | B1 | C1 | Mg chloride | 12.0 | Al sulfate | 4.0 |
| 26 | 26 | A14 | B1 | C1 | Mg chloride | 12.0 | Al sulfate | 4.0 |
| 27 | 27 | A15 | B1 | C1 | Mg chloride | 12.0 | Al sulfate | 4.0 |
| 28 | 28 | A16 | B1 | C1 | Mg chloride | 12.0 | Al sulfate | 4.0 |
| 29 | 29 | A1 | B1 | C1 | — | — | Al sulfate | 16.0 |
| 30 | 30 | A1 | B1 | C1 | Mg chloride | 17.0 | — | — |
| 31 | 31 | A17 | B1 | C1 | Mg chloride | 12.0 | Al sulfate | 4.0 |

TABLE 4-2

| | Physical properties | | | | | |
|---|---|---|---|---|---|---|
| | | | | SP_{A}- | | |
| Toner | M | A | M/A | SP_{C} | MAIM/EGM | MAIM/M_{EG} |
| Type | mmol/kg | mmol/kg | — | — | — | — |
| 1 | 10.0 | 3.0 | 3.3 | 1.21 | 1.19 × 10⁻² | 2.30 × 10⁻² |
| 2 | 10.5 | 3.2 | 3.3 | 1.19 | 1.26 × 10⁻² | 2.42 × 10⁻² |
| 3 | 10.2 | 3.0 | 3.4 | 1.18 | 1.21 × 10⁻² | 2.33 × 10⁻² |
| 4 | 10.1 | 3.4 | 3.0 | 1.21 | 1.24 × 10⁻² | 2.38 × 10⁻² |
| 5 | 10.6 | 3.5 | 3.0 | 1.22 | 1.29 × 10⁻² | 2.49 × 10⁻² |
| 6 | 10.0 | 3.0 | 3.3 | 1.17 | 1.27 × 10⁻² | 2.44 × 10⁻² |
| 7 | 10.0 | 3.0 | 3.3 | 1.16 | 1.29 × 10⁻² | 2.48 × 10⁻² |
| 8 | 10.3 | 3.3 | 3.1 | 1.28 | 1.15 × 10⁻² | 2.21 × 10⁻² |
| 9 | 10.0 | 3.0 | 3.3 | 1.29 | 1.08 × 10⁻² | 2.09 × 10⁻² |
| 10 | 10.1 | 3.4 | 3.0 | 1.04 | 2.11 × 10⁻² | 4.07 × 10⁻² |
| 11 | 10.0 | 3.0 | 3.3 | 1.01 | 2.28 × 10⁻² | 4.39 × 10⁻² |
| 12 | 10.0 | 3.0 | 3.3 | 1.31 | 0.98 × 10⁻² | 1.90 × 10⁻² |
| 13 | 10.0 | 3.0 | 3.3 | 1.35 | 0.93 × 10⁻² | 1.78 × 10⁻² |
| 14 | 50.0 | 50.0 | 1.0 | 1.21 | 9.17 × 10⁻² | 1.77 × 10⁻¹ |
| 15 | 4.0 | 60.0 | 0.1 | 1.21 | 5.87 × 10⁻² | 1.13 × 10⁻¹ |
| 16 | 5.0 | 0.5 | 10.0 | 1.21 | 0.50 × 10⁻² | 0.97 × 10⁻² |
| 17 | 60.0 | 0.3 | 200.0 | 1.21 | 5.53 × 10⁻² | 1.07 × 10⁻¹ |
| 18 | 10.6 | 3.3 | 3.2 | 1.21 | 1.28 × 10⁻² | 2.45 × 10⁻² |
| 19 | 10.7 | 3.6 | 3.0 | 1.21 | 1.31 × 10⁻² | 2.53 × 10⁻² |
| 20 | 10.1 | 3.4 | 3.0 | 1.21 | 1.24 × 10⁻² | 2.38 × 10⁻² |
| 21 | 10.2 | 3.1 | 3.3 | 1.21 | 1.22 × 10⁻² | 2.35 × 10⁻² |
| 22 | 10.5 | 3.0 | 3.5 | 1.21 | 1.15 × 10⁻² | 2.21 × 10⁻² |
| 23 | 10.8 | 3.2 | 3.4 | 1.21 | 1.18 × 10⁻² | 2.27 × 10⁻² |
| 24 | 10.4 | 3.2 | 3.3 | 1.21 | 1.13 × 10⁻² | 2.18 × 10⁻² |
| 25 | 10.0 | 3.0 | 3.3 | 0.99 | 2.50 × 10⁻² | 4.81 × 10⁻² |
| 26 | 10.6 | 3.4 | 3.1 | 1.38 | 0.94 × 10⁻² | 1.82 × 10⁻² |
| 27 | 10.7 | 3.4 | 3.1 | 1.21 | 1.19 × 10⁻² | 2.29 × 10⁻² |
| 28 | 10.5 | 3.3 | 3.2 | 1.21 | 1.15 × 10⁻² | 2.22 × 10⁻² |
| 29 | — | 13.0 | — | 1.21 | 1.19 × 10⁻² | 2.30 × 10⁻² |
| 30 | 13.0 | — | — | 1.21 | 1.19 × 10⁻² | 2.30 × 10⁻² |
| 31 | 10.2 | 3.1 | 3.3 | 1.36 | 0.89 × 10⁻² | 1.72 × 10⁻² |

The abbreviation in Table 4-1 to 4-2 is as follows.

PAC: Polyaluminum chloride

Production example of magnetic core
Step 1 (Weighing/Mixing step)
   Fe₂O₃:61.7% by mass
   MnCO₃:34.2% by mass
   Mg(OH) 2:3.0% by mass
   SrCO₃:1.1% by mass

Ferrite raw materials were weighed so as to satisfy the above condition. Subsequently, grinding and mixing were performed for two hours in a dry ball mill using zirconia balls (10 mm).

### Step 2 (Prefiring Step)

After grinding and mixing, prefiring was performed in air at 950° C. for two hours using a burner-type firing furnace to produce prefired ferrite. The composition of the ferrite is as follows: (MnO) a (MgO) b (SrO) c (Fe₂O₃) d where a=0.40, b=0.07, c=0.01, and d=0.52.

### Step 3 (Grinding Step)

The prefired ferrite was crushed with a crusher to about 0.5 mm. Subsequently, 30 parts by mass of water was added relative to 100 parts by mass of the prefired ferrite, and the mixture was ground in a wet ball mill for two hours using zirconia balls (ϕ 1.0 mm). After the balls were separated, grinding was performed in a wet bead mill for three hours using zirconia beads (ϕ 1.0 mm) to prepare ferrite slurry.

### Step 4 (Granulation Step)

To the ferrite slurry, 2.0 parts by mass of polyvinyl alcohol was added as a binder relative to 100 parts by mass of the prefired ferrite, and the resulting mixture was granulated into spherical particles of 40 μm with a spray dryer (manufacturer: OHKAWARA KAKOHKI CO., LTD.).

### Step 5 (Firing Step)

Firing was performed in an electric furnace in a nitrogen atmosphere (oxygen concentration: 1.0% by volume) at 1,150° C. for four hours in order to control the firing atmosphere.

### Step 6 (Screening Step)

After aggregated particles were disintegrated, coarse particles were removed by sifting with a sieve having an opening of 250 μm to obtain porous magnetic core particles.

### Step 7 (Resin Filling Step)

Into a stirring container of a mixing stirrer (universal stirrer, model NDMV, manufactured by DALTON CORPORATION), 100.0 parts by mass of the porous magnetic core particles were charged. While the temperature was maintained at 60° C. and the pressure was reduced to 2.3 kPa, nitrogen was introduced, and a silicone resin solution was added dropwise thereto under reduced pressure such that the amount was 7.5 parts by mass in terms of resin component relative to the porous magnetic core particles. After completion of the dropwise addition, stirring was continued for two hours. Subsequently, the temperature was raised to 70° C., and the solvent was removed under reduced pressure to fill the inside of the porous magnetic core particles with a silicone resin composition obtained from the silicone resin solution. After cooling, the resulting filled core particles were transferred into a mixer including a rotatable mixing container having spiral blades therein (drum mixer, model UD-AT, manufactured by Sugiyama Heavy Industrial Co., Ltd.), and the temperature was raised to 220° C. in a nitrogen atmosphere at normal pressure at a temperature rise rate of 2° C./min. Heating and stirring were performed at this temperature for 60 minutes to cure the resin. After heat treatment, magnetic separation was performed to remove particles having a low magnetic force. The resulting particles were classified through a sieve having an opening of 150 μm to obtain a magnetic core.

### Method for Producing Cover Resin

Into a four-necked flask equipped with a reflux condenser, a thermometer, a nitrogen inlet tube, and a sealed stirring device, 80 parts by mass of cyclohexyl methacrylate and 20 parts by mass of methyl methacrylate were charged.

Furthermore, 100 parts by mass of toluene, 100 parts by mass of methyl ethyl ketone, and 2.0 parts by mass of azobisisovaleronitrile were added thereto. The resulting mixture was maintained at 70° C. for 10 hours under a stream of nitrogen. After completion of polymerization reaction, washing was repeated to obtain a cover resin solution (solid content: 35% by mass).

### Production Example of Cover Resin Coating Liquid

To the cover resin solution, toluene and methyl ethyl ketone were added in a ratio of 1:1 such that a resin solid content ratio was 5% by mass. The resulting mixture was shaken and stirred for 15 minutes using a paint shaker (manufactured by RADIA) to obtain a resin coating liquid.

### Production Example of Magnetic Carrier 1

The magnetic core was used, and the cover resin coating liquid was charged into a planetary-screw mixer (Nauta Mixer, model VN, manufactured by Hosokawa Micron Corporation) maintained under reduced pressure (1.5 kPa) and at a temperature of 60° C. such that the solid content of the cover resin coating liquid was 3.0 parts by mass relative to 100 parts by mass of the magnetic core. As for the charging method, ⅓ of the resin coating liquid was charged, and solvent removal and a coating operation were performed for 20 minutes. Subsequently, ⅓ of the resin coating liquid was further charged, solvent removal and a coating operation were performed for 20 minutes, ⅓ of the resin coating liquid was then further charged, and solvent removal and a coating operation were performed for 20 minutes.

Subsequently, the resulting mixture was transferred into a mixer including a rotatable mixing container having spiral blades therein (drum mixer, model UD-AT, manufactured by Sugiyama Heavy Industrial Co., Ltd.) and subjected to heat treatment at a temperature of 120° C. in a nitrogen atmosphere for two hours while stirring was performed by rotating the mixing container at 10 rotations per minute. The resulting mixture was subjected to magnetic separation to remove particles having a low magnetic force, passed through a sieve having an opening of 150 μm, and then classified with a wind classifier to obtain a magnetic carrier 1.

### Production Example of Two-Component Developer 1

A two-component developer 1 was obtained by mixing 92.0 parts of the magnetic carrier 1 and 8.0 parts of the toner 1 using a V-type mixer (V-20, manufactured by SEISHIN ENTERPRISE Co., Ltd.).

### Production Examples of Two-Component Developers 2 to 31

Two-component developers 2 to 31 were obtained in the same manner except that, in the production example of the two-component developer 1, the toner was changed as shown in Table 5.

### Examples 1 to 24 and Comparative Examples 1 to 7

Evaluations described below were performed using the two-component developers 1 to 31. The evaluation results are shown in Table 6.

TABLE 5

| | Two-component developer | Toner | Magnetic carrier |
|---|---|---|---|
| Example 1 | Two-component developer 1 | Toner 1 | Magnetic carrier 1 |
| Example 2 | Two-component developer 2 | Toner 2 | Magnetic carrier 1 |
| Example 3 | Two-component developer 3 | Toner 3 | Magnetic carrier 1 |
| Example 4 | Two-component developer 4 | Toner 4 | Magnetic carrier 1 |
| Example 5 | Two-component developer 5 | Toner 5 | Magnetic carrier 1 |
| Example 6 | Two-component developer 6 | Toner 6 | Magnetic carrier 1 |
| Example 7 | Two-component developer 7 | Toner 7 | Magnetic carrier 1 |
| Example 8 | Two-component developer 8 | Toner 8 | Magnetic carrier 1 |
| Example 9 | Two-component developer 9 | Toner 9 | Magnetic carrier 1 |
| Example 10 | Two-component developer 10 | Toner 10 | Magnetic carrier 1 |
| Example 11 | Two-component developer 11 | Toner 11 | Magnetic carrier 1 |
| Example 12 | Two-component developer 12 | Toner 12 | Magnetic carrier 1 |
| Example 13 | Two-component developer 13 | Toner 13 | Magnetic carrier 1 |
| Example 14 | Two-component developer 14 | Toner 14 | Magnetic carrier 1 |
| Example 15 | Two-component developer 15 | Toner 15 | Magnetic carrier 1 |
| Example 16 | Two-component developer 16 | Toner 16 | Magnetic carrier 1 |
| Example 17 | Two-component developer 17 | Toner 17 | Magnetic carrier 1 |
| Example 18 | Two-component developer 18 | Toner 18 | Magnetic carrier 1 |
| Example 19 | Two-component developer 19 | Toner 19 | Magnetic carrier 1 |
| Example 20 | Two-component developer 20 | Toner 20 | Magnetic carrier 1 |
| Example 21 | Two-component developer 21 | Toner 21 | Magnetic carrier 1 |
| Example 22 | Two-component developer 22 | Toner 22 | Magnetic carrier 1 |
| Example 23 | Two-component developer 23 | Toner 23 | Magnetic carrier 1 |
| Example 24 | Two-component developer 24 | Toner 24 | Magnetic carrier 1 |
| Comparative Example 1 | Two-component developer 25 | Toner 25 | Magnetic carrier 1 |
| Comparative Example 2 | Two-component developer 26 | Toner 26 | Magnetic carrier 1 |
| Comparative Example 3 | Two-component developer 27 | Toner 27 | Magnetic carrier 1 |
| Comparative Example 4 | Two-component developer 28 | Toner 28 | Magnetic carrier 1 |
| Comparative Example 5 | Two-component developer 29 | Toner 29 | Magnetic carrier 1 |
| Comparative Example 6 | Two-component developer 30 | Toner 30 | Magnetic carrier 1 |
| Comparative Example 7 | Two-component developer 31 | Toner 31 | Magnetic carrier 1 |

### Evaluations

An imagePRESS C800 full-color copier manufactured by CANON KABUSHIKI KAISHA was modified so as to freely set a fixing temperature and a process speed. A two-component developer was placed in a developing device at a cyan position, an image was formed, and various evaluations were performed while durability tests were conducted.

### Evaluation 1. Evaluation of Low-Temperature Fixability

An apparatus prepared by further detaching a fixing unit from the above modified apparatus was used. An image was output in a single-color mode in a normal-temperature normal-humidity environment (temperature: 23° C., relative humidity: 50% to 60%) at a printing rate of 25% in an unfixed manner such that the toner coverage on paper was 1.3 mg/cm². A copy sheet UPMFG350 (A4, basis weight: 350 g/m²) was used as an evaluation sheet.

Subsequently, in a low-temperature low-humidity environment (temperature: 10° C., relative humidity: 10% or less), the process speed was set to 644 mm/see, and the output unfixed image was fixed while the fixing temperature was sequentially increased by 1.0° C. from 150° C. The detached fixing unit was used for fixing. The lower limit temperature at which offset did not occur was defined as a fixable temperature.

### Evaluation Criteria of Fixable Temperature

AA: lower than 170° C.
A: 170° C. or higher and lower than 175° C.
B: 175° C. or higher and lower than 180° C.
C: 180° C. or higher and lower than 185° C.
D: 185° C. or higher

Evaluation 2. Evaluation of separability
Paper: CS-064 (64.0 g/m²) (available from Canon Marketing Japan Inc.)
Toner coverage on paper: 1.30 mg/cm² (adjusted by direct current voltage VDC of developer-bearing member, charging bias VD of electrostatic latent image-bearing member, and laser power)
Evaluation image: a 2 cm×20 cm image placed on a long edge of the above-mentioned A4 size sheet in the sheet passing direction with a margin of 2 mm from the leading edge of the sheet
Test environment: high-temperature high-humidity environment: temperature 30° C./humidity 80% RH (hereinafter, referred to as “H/H”)
Fixing temperature: The temperature was raised by 5° C. from 140° C. (by 1.0° C. near offset).
Process speed: 644 mm/see

The above evaluation image was output, and the highest fixing temperature at which winding did not occur was checked. The evaluation was performed on the basis of this highest fixing temperature using the following criteria. The ratings of AA to C were determined to be good.

Evaluation criteria of separability
AA: 170° C. or higher
A: 165° C. or higher and lower than 170° C.
B: 160° C. or higher and lower than 165° C.
C: 155° C. or higher and lower than 160° C.
D: lower than 155° C.

### Evaluation 3. Evaluation of Curling Resistance

The evaluation was performed with the above image forming apparatus in a high-temperature high-humidity environment (temperature 35° C., humidity 85% RH) using PB PAPER (66.0 g/m², letter, available from Canon Marketing Japan Inc.) as an evaluation sheet.

An all-solid image with a toner coverage of 1.20 mg/cm² was continuously output on 100 sheets with a leading edge margin of 3 mm, a rear edge margin of 3 mm, and right and left margins of 3 mm in a single-sided continuous print mode.

In the same environment, the 100 sheets were stacked such that the solid-image surfaces after the image output faced upward., and a weight having a size of 210 mm×30 mm and a weight of 100 g was then placed on the rear-edge side such that the side face with a length of 210 mm and lines of the rear edges of the sheets were aligned with each other. Subsequently, the height on the rear-edge side of the sheets and the height on the leading-edge side of the sheets were measured. The height on the rear-edge side was subtracted from the height on the leading-edge side, and the difference was then divided by the height on the rear-edge side and multiplied by 100 to thereby determine a height ratio (%). The larger the height ratio, the more curling occurs. The evaluation was performed on the basis of the following criteria.

Evaluation criteria of curling resistance
AA: The height ratio is less than 4%.
A: The height ratio is 4% or more and less than 8%.
B: The height ratio is 8% or more and less than 12%.
C: The height ratio is 12% or more and less than 16%.
D: The height ratio is 16% or more.

### Evaluation 4. Evaluation of Dispersibility of Release Agent

Dispersibility of a release agent was evaluated by the maximum diameter of a domain of the release agent. The maximum diameter of the domain was measured by a method described below.

Method for observing toner particle cross section stained with ruthenium using scanning transmission electron microscope (STEM)

The cross-sectional observation of toner particles with a scanning transmission electron microscope (STEM) can be performed as described below. The observation is performed by staining toner particle cross sections with ruthenium. Since a crystalline polyester and a release agent that are contained in a toner have crystallinity, they are stained with ruthenium compared with an amorphous resin such as a binder resin. This results in a clearer contrast and facilitates the observation. The amount of ruthenium atoms differs depending on the intensity of the staining. Accordingly, areas that are strongly stained have a large number of these atoms, an electron beam does not pass through the areas, and such areas appear black on the observed image. On the other hand, an electron beam easily passes through areas that are weakly stained, and such areas appear white on the observed image.

First, a toner is spread on a cover glass (square cover glass, square No. 1, manufactured by Matsunami Glass Ind., Ltd.) so as to form a single layer. An Os film (5 nm) and a naphthalene film (20 nm) are formed as protective films on the toner particles using an osmium plasma coater (OPC80T, manufactured by Filgen, Inc.). Next, a PTFE tube (q 1.5 mm× q 3 mm×3 mm) is filled with a photocurable resin D800 (JEOL Ltd.), and the cover glass is gently placed on the tube in such a direction that the toner particles come into contact with the photocurable resin D800. Light is applied in this state to cure the resin, and the cover glass and the tube are then removed to form a cylindrical resin in which the toner particles are embedded in the outermost surface. The outermost surface of the cylindrical resin is cut with an ultrasonic ultramicrotome (UC7, Leica microsystems) at a cutting speed of 0.6 mm/s by a length corresponding to the radius of the toner (4.0 μm when the weight-average particle diameter (D4) is 8.0 μm) to expose cross sections of the toner particles. Next, the resin was then cut to a film thickness of 250 nm to prepare a thin sample of toner particle cross sections. Cross sections of central portions of toner pacrticles can be prepared by cutting with this method.

The resulting thin sample was stained with a vacuum electron staining apparatus (VSC4R1H, Filgen Inc.) for 15 minutes in an atmosphere of a RuO₄ gas at a pressure of 500 Pa, and STEM observation was performed using the STEM function of a scanning transmission electron microscope (JEM2800, JEOL Ltd.). The probe size of the STEM is 1 nm, and an image with an image size of 1,024×1,024 pixels was acquired. The Contrast and Brightness of the Detector Control panel of a bright-field image were adjusted to 1,425 and 3,750, respectively, the Contrast, Brightness, and Gamma of the Image Control panel were adjusted to 0.0, 0.5, and 1.00, respectively, and an image was then acquired.

### Measurement of Maximum Diameter of Domain of Release Agent

The measurement of the domain diameter of the release agent is performed on the basis of an STEM image obtained by the observation of toner particle cross sections stained with ruthenium using the scanning transmission electron microscope (STEM), and among domains A of the release agent, the maximum diameter of the domain having the largest area is measured. The maximum diameters of the domains in the cross sections of 100 toner particles were each measured, the arithmetic average value thereof was defined as the maximum diameter of the domains of the release agent, and dispersibility of the release agent was determined in accordance with the following criteria.

### Evaluation Criteria of Dispersibility of Release Agent

AA: The maximum diameter of domains is less than 500 nm.
A: The maximum diameter of domains is 500 nm or more and less than 1,000 nm.
B: The maximum diameter of domains is 1,000 nm or more and less than 1,500 nm.
C: The maximum diameter of domains is 1,500 nm or more and less than 2,000 nm.
D: 2,000 nm or more

### Evaluation 5. Charge Retention Ability

Paper: GFC-081 (81.0 g/m²) (Canon Marketing Japan Inc.)
Toner coverage on paper: 0.35 mg/cm²
   (adjusted by direct current voltage VDC of developer-bearing member, charging bias VD of electrostatic latent image-bearing member, and laser power)
Evaluation image: a 2 cm×5 cm image placed at the center of the above-mentioned A4 size sheet
Fixing test environment: high-temperature high-humidity environment: temperature 30° C./humidity 80% RH (hereinafter, referred to as “H/H”)
Process speed: 644 mm/see

A toner on the electrostatic latent image-bearing member was collected by suction using a metal cylinder and a cylindrical filter to thereby calculate the triboelectric charging amount of the toner. Specifically, the triboelectric charging amount of the toner on the electrostatic latent image-bearing member was measured with a Faraday-Cage. The Faraday-Cage includes a coaxial double cylinder formed of an inner cylinder and an outer cylinder that are insulated from each other. When a charged substance with a charge amount Q is put in the inner cylinder, electrostatic induction produces a state where a metal cylinder with a charge amount Q exists virtually. The induced charge amount was measured with an electrometer (Keithley 6517A, manufactured by Keithley Instruments, Inc.), and a value (Q/M) calculated by dividing the charge amount Q (mc) by the mass M (kg) of the toner in the inner cylinder was defined as a triboelectric charging amount of the toner.

$$Triboelectric charging amount of toner ( mC / kg ) = Q / M$$

First, the above evaluation image was formed on the electrostatic latent image-bearing member, and before the evaluation image was transferred to an intermediate transfer member, the rotation of the electrostatic latent image-bearing member was stopped. The toner on the electrostatic latent image-bearing member was collected by suction using a metal cylinder and a cylindrical filter to measure an [initial Q/M].

Subsequently, after the developing device was left to stand in the evaluation apparatus for two weeks in the H/H environment, the same operation as before the developing device was left to stand was performed to measure the charge amount Q/M per unit mass (mC/kg) on the electrostatic latent image-bearing member after being left to stand. The initial Q/M per unit mass on the electrostatic latent image-bearing member was assumed to be 100%, and a retention rate of Q/M per unit mass on the electrostatic latent image-bearing member after being left to stand ([Q/M after left to stand]/[initial Q/M]×100) was calculated and evaluated in accordance with the following criteria. The ratings of A to C were determined to be good.

Evaluation criteria of charge retention ability
A: The retention rate is 95% or more.
B: The retention rate is 90% or more and less than 95%.
C: The retention rate is 85% or more and less than 90%.
D: The retention rate is less than 85%.

TABLE 6

| | | | | | Evaluation 3 | | | | Evaluation 5 | |
|---|---|---|---|---|---|---|---|---|---|---|
| | Evaluation 1 | | Evaluation 2 | | Curling | | Evaluation 4 | | Charge retention | |
| | Low-temperature | | Separability/ | | resistance | | Dispersibility | | ability | |
| | fixability | | Peelability | | | Height | of release agent | | | Retention |
| | | ° C. | | ° C. | | ratio | | nm | | rate |
| Example 1 | AA | 167 | AA | 173 | AA | 2% | AA | 420 | A | 97 |
| Example 2 | AA | 164 | AA | 172 | AA | 2% | AA | 360 | A | 98 |
| Example 3 | AA | 164 | AA | 171 | AA | 2% | AA | 360 | B | 93 |
| Example 4 | AA | 168 | AA | 175 | AA | 2% | AA | 370 | A | 97 |
| Example 5 | AA | 168 | AA | 175 | AA | 2% | AA | 410 | B | 92 |
| Example 6 | AA | 164 | AA | 170 | AA | 2% | AA | 380 | A | 97 |
| Example 7 | AA | 164 | A | 168 | AA | 2% | AA | 430 | A | 97 |
| Example 8 | AA | 168 | AA | 178 | AA | 2% | A | 680 | A | 97 |
| Example 9 | AA | 169 | AA | 179 | AA | 2% | B | 1120 | A | 97 |
| Example 10 | AA | 162 | B | 164 | AA | 2% | AA | 480 | A | 97 |
| Example 11 | AA | 160 | C | 159 | AA | 2% | AA | 460 | A | 97 |
| Example 12 | B | 177 | AA | 178 | AA | 2% | B | 1340 | A | 97 |
| Example 13 | C | 180 | AA | 181 | AA | 2% | C | 1650 | A | 97 |
| Example 14 | B | 175 | AA | 176 | B | 7% | AA | 480 | A | 97 |
| Example 15 | A | 174 | AA | 174 | C | 13% | AA | 390 | A | 97 |
| Example 16 | AA | 160 | C | 159 | AA | 3% | AA | 450 | A | 97 |
| Example 17 | A | 172 | A | 169 | B | 8% | AA | 440 | A | 97 |
| Example 18 | AA | 167 | AA | 171 | AA | 2% | AA | 360 | A | 97 |
| Example 19 | AA | 167 | AA | 173 | AA | 2% | AA | 350 | A | 97 |
| Example 20 | AA | 168 | AA | 172 | AA | 2% | AA | 400 | A | 97 |
| Example 21 | AA | 166 | AA | 173 | AA | 2% | AA | 470 | A | 97 |
| Example 22 | AA | 167 | AA | 172 | AA | 2% | A | 710 | A | 97 |
| Example 23 | AA | 165 | AA | 172 | AA | 2% | B | 930 | A | 97 |
| Example 24 | AA | 166 | B | 168 | AA | 2% | AA | 320 | A | 97 |
| Comparative | AA | 155 | D | 154 | AA | 2% | AA | 350 | A | 97 |
| Example 1 | | | | | | | | | | |
| Comparative | D | 185 | AA | 183 | AA | 2% | A | 890 | A | 97 |
| Example 2 | | | | | | | | | | |
| Comparative | D | 185 | AA | 171 | AA | 2% | D | 2210 | A | 97 |
| Example 3 | | | | | | | | | | |
| Comparative | AA | 167 | D | 154 | AA | 2% | AA | 260 | A | 97 |
| Example 4 | | | | | | | | | | |
| Comparative | AA | 167 | AA | 171 | D | 19% | AA | 430 | A | 97 |
| Example 5 | | | | | | | | | | |
| Comparative | AA | 167 | D | 154 | AA | 2% | AA | 410 | A | 97 |
| Example 6 | | | | | | | | | | |
| Comparative | D | 185 | AA | 176 | AA | 2% | B | 1080 | A | 97 |
| Example 7 | | | | | | | | | | |

According to the present disclosure, even in the case where a toner contains polyethylene terephthalate, low-temperature fixability and separability can be combined, and curling resistance can be achieved in a high-speed apparatus. Polyethylene terephthalate recycled from used PET bottles and the like can be used as a material of a toner. The technologies described in this specification have the potential to contribute to the achievement of a sustainable society, such as a decarbonized society/circular society.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-049225 filed Mar. 26, 2024 and No. 2025-030139 filed Feb. 27, 2025, which are hereby incorporated by reference herein in their entirety.

What is claimed is:

1. A toner comprising:
toner particles containing a binder resin and a release agent,
wherein the binder resin contains an amorphous resin A and a crystalline polyester C,
the amorphous resin A is a polyester and has, as a structure that forms a polyester backbone,
(i) a polyethylene terephthalate structural moiety, and
(ii) at least one structure selected from the group consisting of a unit represented by formula (1), a unit represented by formula (2), a unit represented by formula (3), and a unit represented by formula (4), 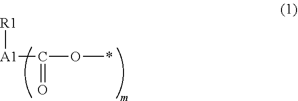
in formula (1), R1 represents an alkyl group having 6 to 16 carbon atoms or an alkenyl group having 6 to 16 carbon atoms,
A1 represents a hydrocarbon group,
* represents a bonding site in the polyester backbone, and
m represents an integer of 2 or more; 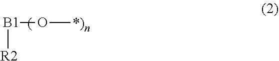
in formula (2), R2 represents an alkyl group having 6 to 16 carbon atoms or an alkenyl group having 6 to 16 carbon atoms,
B1 represents a hydrocarbon group,
* represents a bonding site in the polyester backbone, and
n represents an integer of 2 or more; 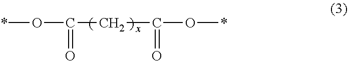
in formula (3), each * represents a bonding site in the polyester backbone, and
x represents an integer of 6 to 16; 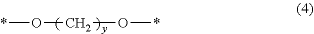
in formula (4), each * represents a bonding site in the polyester backbone, and
y represents an integer of 6 to 16;
an SP value of the amorphous resin A is represented by SP_{A} (cal/cm³) 0.5, an SP value of the crystalline polyester C is represented by SP_{C} (cal/cm³) 0.5, and SP_{A} and SP_{C} satisfy formula (C);
$$1. \leq {SP}_{A} - {SP}_{C} \leq 1.35 ; \qquad ( C )$$
the toner contains at least one metal element selected from the group consisting of calcium, magnesium, sodium, and barium and contains aluminum.

2. The toner according to claim 1, wherein a ratio M/A of a total content M (mmol/kg) of calcium, magnesium, sodium, and barium in the toner to a content A (mmol/kg) of the aluminum in the toner satisfies formula (D);
$$1. \leq M / A \leq 10. . \qquad ( D )$$

3. The toner according to claim 1,
wherein a total content M (mmol/kg) of calcium, magnesium, sodium, and barium in the toner is 5.0 mmol/kg or more and 50.0 mmol/kg or less, and
a content A (mmol/kg) of the aluminum in the toner is 0.5 mmol/kg or more and 50.0 mmol/kg or less.

4. The toner according to claim 1, wherein a ratio of an ethylene glycol-derived structure of the polyethylene terephthalate structural moiety to a total number of moles of an alcohol-derived structure and a carboxylic acid-derived structure forming the polyester backbone in the amorphous resin A is represented by WEG (% by mole), and WEG satisfies formula (E);
$$12.6 \leq {W}_{EG} \leq 24.8 . \qquad ( E )$$

5. The toner according to claim 1, wherein a ratio of a total of the unit represented by formula (1), the unit represented by formula (2), the unit represented by formula (3), and the unit represented by formula (4) to a total number of moles of an alcohol-derived structure and a carboxylic acid-derived structure forming the polyester backbone in the amorphous resin A is represented by WCH (% by mole), and WCH satisfies formula (F);
$$5.6 \leq {W}_{CH} \leq 1 \; 4.6 . \qquad ( F )$$

6. The toner according to claim 1, wherein a glass transition temperature of the amorphous resin A is represented by Tg_{A} (° C.), and Tg_{A} satisfies formula (G);
$$40. \leq {Tg}_{A} \leq 55. . \qquad ( G )$$

7. The toner according to claim 1, wherein the crystalline polyester C is a modified crystalline polyester having a structure in which a hydroxy group at a terminal of a main chain is terminally modified with an aliphatic monocarboxylic acid having 16 to 31 carbon atoms or a modified crystalline polyester having a structure in which a carboxy group at a terminal of a main chain is terminally modified with an aliphatic monoalcohol having 15 to 30 carbon atoms.

8. The toner according to claim 1, wherein the amorphous resin A contains the unit represented by formula (1) or the unit represented by formula (2).
